(19) United States
(12) Patent Application Publication
(10) Pub. No.: US 2025/0139819 A1
(43) Pub. Date: May 1, 2025

(54) CAMERA SYSTEM POSE DETERMINATION METHOD, DEVICE, MOVABLE PLATFORM, AND RELATED PRODUCTS

(71) Applicant: Arashi Vision Inc., Shenzhen (CN)

(72) Inventors: Liu CHENXI, Shenzhen (CN); Tan MINGLANG, Shenzhen (CN); Lai DONGDONG, Shenzhen (CN); Xie LIANG, Shenzhen (CN)

(73) Assignee: Arashi Vision Inc., Shenzhen (CN)

(21) Appl. No.: 18/927,030

(22) Filed: Oct. 25, 2024

(30) Foreign Application Priority Data
Oct. 25, 2023 (CN) 202311391909X

(51) Int. Cl. G06T 7/73; G06T 7/246; G06T 7/55

(52) U.S. Cl. CPC G06T 7/73; G06T 7/246; G06T 7/55; G06T 2207/10016; G06T 2207/30244

(57) ABSTRACT

A method for determining a pose of a camera system may include obtaining a current frame fisheye image captured by a fisheye camera in the camera system and a current frame ordinary image captured by a preset type of camera in the camera system; tracking feature points of the current frame fisheye image to obtain current frame fisheye feature points of the current frame fisheye image, and tracking feature points of the current frame ordinary image to obtain current frame ordinary feature points of the current frame ordinary image; and determining current pose information of the camera system according to the current frame fisheye feature points and the current frame ordinary feature points.

### CROSS-REFERENCE TO RELATED APPLICATION

The present application claims the priority of Chinese Patent Application No. CN 202311391909X, filed on Oct. 25, 2023, the content of which is incorporated herein by reference in its entirety.

### TECHNICAL ANGLE

The present application relates to the field of positioning technology, and in particular to a method, device, movable platform and related products for determining a pose of a camera system.

### BACKGROUND

With development of image processing technology, visual positioning technology has been widely used. Taking positioning of a camera system as an example, in the related technology, visual positioning processing is mainly performed on images collected by each camera in the camera system to determine the pose information of the camera system. However, in the related art, there is a problem that the determined pose information of the camera system is inaccurate.

### SUMMARY

Based on this, it is necessary to provide a method, device, movable platform and related products for determining the pose of a camera system in order to address the above-mentioned technical problems, so as to improve accuracy of the determined pose information of the camera system.

In one embodiment, a method for determining a pose of a camera system may include obtaining a current frame fisheye image captured by a fisheye camera in the camera system and a current frame ordinary image captured by a preset type camera in the camera system; tracking feature points of the current frame fisheye image to obtain current frame fisheye feature points of the current frame fisheye image, and tracking feature points of the current frame ordinary image to obtain current frame ordinary feature points of the current frame ordinary image; and determining current pose information of the camera system according to the current frame fisheye feature points and the current frame ordinary feature points.

In another embodiment, a device for determining a pose of a camera system may include a camera system comprising a fisheye camera and a preset type of camera; and circuitry configured to acquire a current frame fisheye image by the fisheye camera in a camera system and a current frame ordinary image by the preset type of camera in the camera system; track feature points of the current frame fisheye image to obtain current frame fisheye feature points of the current frame fisheye image, and track feature points of the current frame ordinary image to obtain current frame ordinary feature points of the current frame ordinary image; and determine current pose information of the camera system according to the current frame fisheye feature points and the current frame ordinary feature points.

In one embodiment, a movable platform, comprising the camera system; at least one processor; and

at least one memory storing a computer program; wherein the computer program, when executed by the at least one processor, causes the at least one processor to perform the method according to one embodiment of the present application.

In one embodiment, a computer device may comprise at least one memory and at least one processor, wherein the at least one memory stores a computer program which, when executed by the at least one processor, causes the at least one processor to perform the method according to one embodiment of the present application.

In one embodiment, a non-transitory computer-readable storage medium has a computer program stored thereon which, when executed by a processor, causes the processor to perform the method according to one embodiment of the present application.

The camera system pose determination method, device, movable platform and related products are provided by some embodiments of the present application. In one embodiment, the camera system pose determination method includes: obtaining a current frame fisheye image captured by a fisheye camera in the camera system and a current frame ordinary image captured by a preset type of camera, tracking feature points of the current frame fisheye image to obtain current frame fisheye feature points of the current frame fisheye image, and tracking feature points of the current frame ordinary image to obtain current frame ordinary feature points of the current frame ordinary image, and determining current pose information of the camera system based on the current frame fisheye feature points and the current frame ordinary feature points. The above method can compensate for the preset type of camera by using a fisheye camera with a large field of view in the camera system. The present type of camera's field of view is small, and the fisheye image collected by the fisheye camera makes up for the weak texture defect of ordinary images collected by the preset type of camera, so that more feature points from the surrounding environment can be obtained in the process of determining the pose of the camera system. Further determining the pose of the camera system by more feature points can improve accuracy of the determined pose information of the camera system; at the same time, since the fisheye camera has a unique imaging model, the movement of the same feature point in the inter-frame image is small, stable and not easy to lose, thereby improving accuracy of feature point tracking. On this basis, the accuracy of the determined pose of the camera system can be further improved.

It should be understood that the above general description and the detailed description that follows are exemplary and explanatory only and do not limit the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a diagram showing an application environment of a method for determining a pose of a camera system in one embodiment;

FIG. 2 is a schematic flow chart of a method for determining a pose of a camera system in one embodiment;

FIG. 3 is a schematic flow chart of a method for determining a pose of a camera system in one embodiment;

FIG. 4 is a schematic flow chart of a method for determining a pose of a camera system in one embodiment;

FIG. 5 is a schematic flow chart of a method for determining a pose of a camera system in one embodiment;

FIG. 6 is a schematic flow chart of a method for determining a pose of a camera system in one embodiment;

FIG. 7 is a schematic flow chart of a method for determining a pose of a camera system in one embodiment;

FIG. 8 is a schematic flow chart of a method for determining a pose of a camera system in one embodiment;

FIG. 9 is a schematic flow chart of a method for determining a pose of a camera system in one embodiment;

FIG. 10 is a schematic flow chart of a method for determining a pose of a camera system in one embodiment;

FIG. 11 is a schematic flow chart of a method for determining a pose of a camera system in one embodiment;

FIG. 12 is a schematic flow chart of a method for determining a pose of a camera system in one embodiment;

FIG. 13 is a schematic flow chart of a method for determining a pose of a camera system in one embodiment;

FIG. 14 is a schematic flow chart of a method for determining a pose of a camera system in one embodiment;

FIG. 15 is a schematic flow chart of a method for determining a pose of a camera system in one embodiment;

FIG. 16 is a flow chart of a pose estimation process for a camera system in one embodiment;

FIG. 17 is a structural block diagram of a device for determining a pose of a camera system in one embodiment;

FIG. 18 is a diagram showing an internal structure of a computer device in one embodiment.

### DETAILED DESCRIPTION

In order to make the purpose, technical solution and advantages of the present application more clearly understood, the present application is further described in detail below in conjunction with the accompanying drawings and embodiments. It should be understood that the specific embodiments described herein are only used to explain the present application and are not used to limit the present application.

In the field of photography, camera systems (including multiple cameras) are required in some photography scenes. In practical applications, the pose information of the camera system needs to be estimated. In the related art, the images collected by each ordinary camera in the camera system are mainly processed by visual positioning to determine the pose information of the camera system. However, in the related art, due to the small field of view of ordinary cameras, there will be problems such as missing feature points in adjacent frame images and feature points are easily lost. Accordingly, there are problems such as inaccurately determined pose information of the camera system. Based on this, an embodiment of the present application provides a method for determining the pose of a camera system, which can improve accuracy of the determined pose information of the camera system.

One embodiment of the present application provides a method for determining a pose of a camera system which can be applied to scenes where each camera in the camera system moves rapidly, and can be, for example, applied to a movable platform as shown in FIG. 1. The pose of the camera system may include position and/or attitude of the camera system. The movable platform can include a processor and a camera system, and the processor and the camera system can be connected in communication. Among them, the above-mentioned movable platform can be an unmanned robot, an unmanned vehicle, an unmanned ship, and other movable devices. In one embodiment of the present application, the above-mentioned movable platform can be a drone, and the specific form of the movable platform is not limited in this embodiment. Optionally, the above-mentioned camera system can include at least one fisheye camera and at least one preset type of camera. Optionally, a fisheye camera refers to a camera with a field of view close to or greater than 180 degrees. Relatively, a preset type camera can be understood as a non-fisheye camera, such as an ordinary camera with a field of view of less than 90 degrees; FIG. 1 is an example in which the movable platform is a drone, and the camera system includes a fisheye camera and a preset type of camera. A specific process of the method for determining the pose of a camera system will be introduced in the following embodiment, and the specific process of the method for determining the pose of a camera system will be introduced by taking a movable platform as an example of the execution subject.

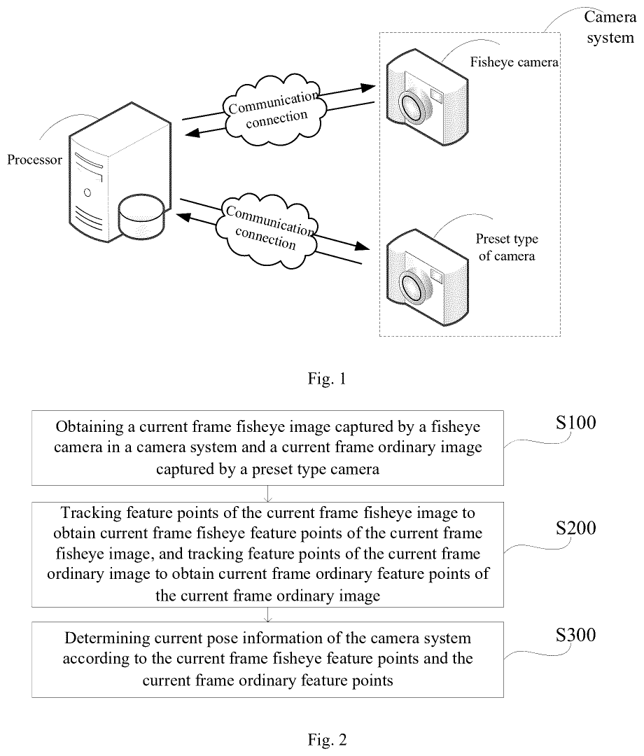

FIG. 2 shows a flow chart of a method for determining a pose of a camera system provided in an embodiment of the present application. The method may include the following steps:

S100: obtaining a current frame fisheye image captured by a fisheye camera in a camera system and a current frame ordinary image captured by a preset type camera.

Among them, the camera system may include a fisheye camera and a preset type of camera. The fisheye camera and the preset type of camera are deployed at different locations. It should be noted here that the image captured by the fisheye camera can be called a fisheye image, and relatively, the image captured by the preset type of camera can be called an ordinary image.

Optionally, the current frame fisheye image captured by the fisheye camera can be understood as the fisheye image captured by the fisheye camera at the current moment; the current frame ordinary image captured by the preset type of camera can be understood as the ordinary image captured by the preset type of camera at the current moment.

In practical applications, due to factors such as different spacings between the fisheye camera and the preset type of camera and the computer device, and different transmission speeds, a computer device can naturally use a synchronous method to receive the current frame fisheye image sent by the fisheye camera and the current frame ordinary image sent by the preset type of camera, or use an asynchronous method to receive the current frame fisheye image sent by the fisheye camera and the current frame ordinary image sent by the preset type of camera.

S200: tracking feature points of the current frame fisheye image to obtain current frame fisheye feature points of the current frame fisheye image, and tracking feature points of the current frame ordinary image to obtain current frame ordinary feature points of the current frame ordinary image.

Optionally, the computer device can use a feature point tracking algorithm to track the feature points of the current frame fisheye image to obtain the current frame fisheye feature points of the current frame fisheye image. At the same time, it can use a feature point tracking algorithm to track the feature points of the current frame ordinary image to obtain the current frame ordinary feature points of the current frame ordinary image.

Optionally, the feature point tracking algorithm may be an optical flow tracking method, a target tracking method, a feature point matching method, etc., which is not limited in the embodiments of the present application.

In addition, the computer device can also pre-train a feature point tracking model, and then input the current frame fisheye image into the feature point tracking model, which tracks the feature points of the current frame fisheye image and outputs the current frame fisheye feature points of the current frame fisheye image; at the same time, the current frame ordinary image can also be input into the feature point tracking model, which tracks the feature points of the current frame ordinary image and outputs the current frame ordinary feature points of the current frame ordinary image.

Among them, the above-mentioned feature point tracking model can include at least one of a convolutional neural network model, a fully connected neural network model, a recurrent neural network model, a deep belief network model, a deep autoencoder or a generative adversarial network model, which is not limited to the embodiments of the present application.

S300: determining current pose information of the camera system according to the current frame fisheye feature points and the current frame ordinary feature points.

In practical applications, the computer device can perform fusion processing, rotation processing, and translation transformation processing on the current frame fisheye feature points and the current frame ordinary feature points to obtain the current pose information of the camera system. Optionally, the above current pose information may include a rotation matrix and a translation vector of the camera system. Among them, the rotation matrix at the i-th moment can be expressed as R_{Bi}^{W}, and the translation vector at the i-th moment can be expressed as t_{Bi}^{W}.

It should be noted here that at time zero, the rotation matrix of the camera system can be the unit matrix, and the translation vector of the camera system can be the zero vector.

The technical solution in one embodiment of the present application is to obtain a current frame fisheye image captured by a fisheye camera in a camera system and a current frame ordinary image captured by a preset type of camera, track feature points of the current frame fisheye image to obtain current frame fisheye feature points of the current frame fisheye image, and track feature points of the current frame ordinary image to obtain current frame ordinary feature points of the current frame ordinary image, and determine the current pose information of the camera system according to the current frame fisheye feature points and the current frame ordinary feature points; the above method can compensate for the small field of view of the preset type camera by a fisheye camera with a large field of view in the camera system, and compensate for the defect of weak texture in the ordinary image captured by the preset type of camera by a fisheye image captured by the fisheye camera, so that more feature points from the surrounding environment can be obtained in the process of determining the pose of the camera system. As such, the pose of the camera system can be determined by more feature points, which can further improve the accuracy of the determined pose of the camera system; at the same time, because the fisheye camera has a unique imaging model, the movement of the same feature point in inter-frame images is small, stable and not easy to lose, thereby improving accuracy of feature point tracking, and on this basis, the accuracy of the determined pose of the camera system can be further improved.

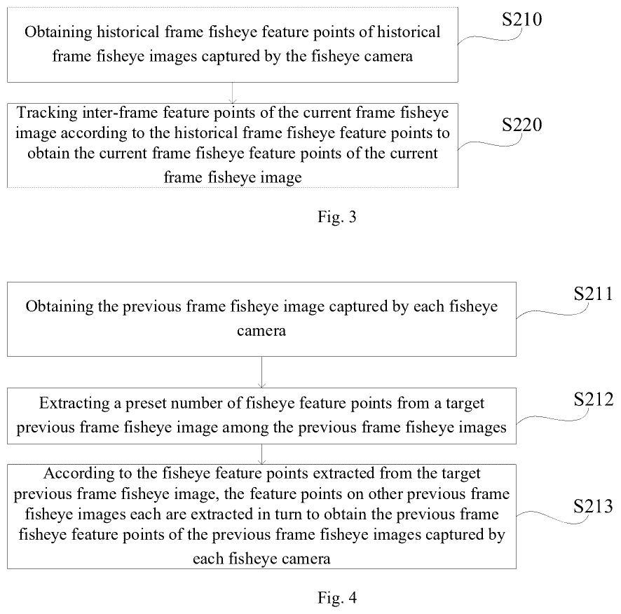

In one embodiment, the process of tracking the feature points of the current frame fisheye image to obtain the current frame fisheye feature points of the current frame fisheye image is described below. In one embodiment, as shown in FIG. 3, the step of tracking the feature points of the current frame fisheye image to obtain the current frame fisheye feature points of the current frame fisheye image in S200 can be implemented in the following manner:

S210: obtaining historical frame fisheye feature points of historical frame fisheye images captured by the fisheye camera.

Among them, the above-mentioned historical frame fisheye images can include any multiple frames of fisheye images before the current frame. For example, the historical frame fisheye images can include any two frames of fisheye images, any three frames of fisheye images, any four frames of fisheye images, etc. before the current frame.

In practical applications, the historical frame fisheye images collected by the fisheye camera can be stored in a local location, a cloud location, a disk or a hard disk, etc. Correspondingly, the computer device can obtain the historical frame fisheye images collected by the fisheye camera from a local location, a cloud location, a disk or a hard disk, etc., and then use a feature point extraction algorithm to extract feature points of the historical frame fisheye images to obtain feature points of the historical frame fisheye images, that is, the historical frame fisheye feature points of the historical frame fisheye images.

Optionally, the feature point extraction algorithm may be a grayscale-based corner detection algorithm, a fast corner detection algorithm, or a deep learning-based corner detection algorithm.

S220: tracking inter-frame feature points of the current frame fisheye image according to the historical frame fisheye feature points to obtain the current frame fisheye feature points of the current frame fisheye image.

In practical applications, the computer device may use a feature point tracking algorithm to track the inter-frame feature points of the current frame fisheye image based on the historical frame fisheye feature points to obtain the current frame fisheye feature points of the current frame fisheye image.

In one embodiment, the camera system includes at least one fisheye camera; if the historical frame fisheye image includes a previous frame fisheye image of the current frame fisheye image, and the previous frame fisheye image is the initial frame fisheye image, then as shown in FIG. 4, the step of obtaining the historical frame fisheye feature points of the historical frame fisheye image acquired by the fisheye camera in S210 can be implemented in the following manner:

S211: obtaining the previous frame fisheye image captured by each fisheye camera.

In one embodiment of the present application, the historical frame fisheye image includes a previous frame fisheye image of the current frame fisheye image. Wherein, when the previous frame fisheye image is an initial frame fisheye image, the initial frame fisheye image can be understood as a fisheye image captured by the fisheye camera at the initial moment during the shooting process of the camera system.

In an embodiment of the present application, the camera system may include at least one fisheye camera. Specifically, the computer device may obtain the previous frame fisheye image captured by each fisheye camera from a local location, a cloud, a disk, or a hard disk.

In practical applications, the sizes of fisheye images captured by different fisheye cameras may be equal or unequal, which is not limited in the embodiments of the present application.

S212: extracting a preset number of fisheye feature points from a target previous frame fisheye image among the previous frame fisheye images, wherein the target previous frame fisheye image refers to any one of the previous frame fisheye images.

The computer device may select any previous frame fisheye image from all previous frame fisheye images as the target previous frame fisheye image, and then use a feature point extraction algorithm to extract a preset number of fisheye feature points from the target previous frame fisheye image.

Optionally, the preset number of fisheye features may be user-defined or determined by historical experience values. However, in the embodiment of the present application, the preset number of fisheye features may be equal to the maximum number of feature points of the fisheye image.

S213: according to the fisheye feature points extracted from the target previous frame fisheye image, the feature points on other previous frame fisheye images each are extracted in turn to obtain the previous frame fisheye feature points of the previous frame fisheye images captured by each fisheye camera.

Optionally, the computer device can pre-train an algorithm model, and then input the feature points extracted from the target previous frame fisheye image and each other previous frame fisheye image into the algorithm model. The algorithm model extracts the feature points on the other previous frame fisheye images among the previous frame fisheye images in turn, and then outputs the previous frame fisheye feature points of each other previous frame fisheye image.

In addition, the computer device can also use a feature point extraction algorithm to extract feature points from each other previous frame fisheye image based on the feature points extracted from the target previous frame fisheye image, and obtain the previous frame fisheye feature points of other previous fisheye images.

It should be noted here that the previous frame fisheye feature points of the previous frame fisheye image captured by each fisheye camera may include feature points extracted from the target previous frame fisheye image and feature points of each other previous frame fisheye image.

In an embodiment of the present application, if the previous frame fisheye image is not the initial frame fisheye image, the method for obtaining the previous frame fisheye feature points of the previous frame fisheye image can include obtaining the fisheye feature points of the previous frame fisheye image corresponding to the fisheye image at the previous moment, and then tracking the inter-frame feature points of the other previous frame fisheye image based on the fisheye feature points of the previous frame fisheye image corresponding to the fisheye image at the previous moment to obtain the previous frame fisheye feature points of the other previous frame fisheye image.

It can be understood that, except for the initial frame fisheye image, the method for obtaining the fisheye feature points of each other previous frame fisheye image is to track the inter-frame feature points of the other previous frame fisheye image according to the fisheye feature points of the previous frame fisheye image corresponding to the previous moment so as to obtain the fisheye feature points of the other previous frame fisheye image.

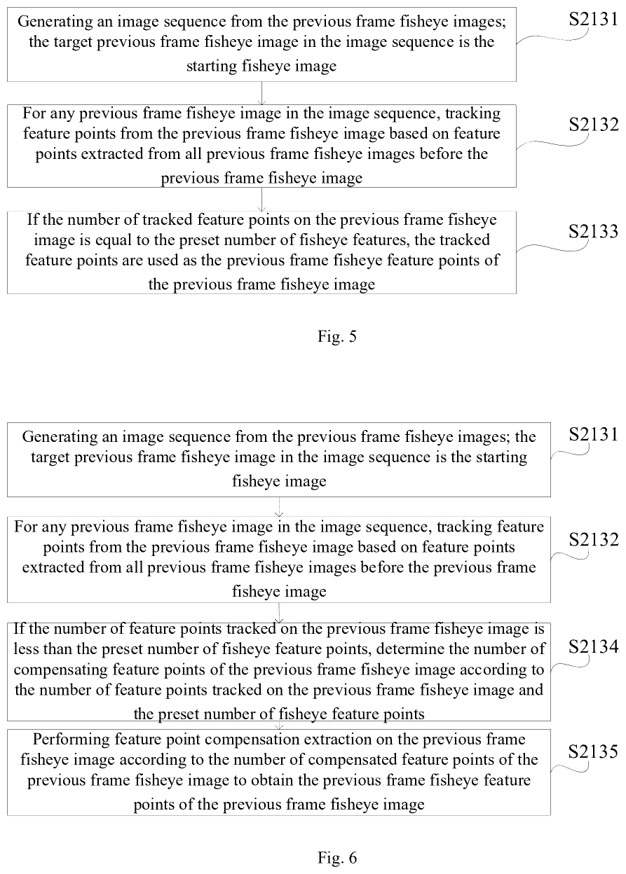

In one embodiment, as shown in FIG. 5, the step of sequentially extracting feature points on other previous frame fisheye images of the previous frame fisheye images according to the feature points extracted on the target previous frame fisheye image in S213 can be implemented in the following manner:

S2131: generating an image sequence from the previous frame fisheye images; the target previous frame fisheye image in the image sequence is the starting fisheye image.

Optionally, the computer device can use the target previous frame fisheye image as the starting fisheye image, and sort the previous frame fisheye images according to information such as the deployment position of each fisheye camera, the resolution of the captured image or the production time so as to generate an image sequence.

S2132: For any previous frame fisheye image in the image sequence, tracking feature points from the previous frame fisheye image based on feature points extracted from all previous frame fisheye images before the previous frame fisheye image.

For example, the image sequence includes a previous fisheye image 1, a previous fisheye image 2, a previous fisheye image 3 and a previous fisheye image 4, wherein the previous fisheye image 1 is the target previous frame fisheye image. For the previous fisheye image 2, the feature points of the previous fisheye image 2 can be tracked according to the feature points extracted from the previous fisheye image 1, so as to track the feature points from the previous fisheye image 2; for the previous fisheye image 4, the feature points of the previous fisheye image 4 can be tracked according to the feature points extracted from the previous fisheye image 1, the previous fisheye image 2 and the previous fisheye image 3, so as to track the feature points from the previous fisheye image 4.

S2133: If the number of tracked feature points on the previous frame fisheye image is equal to the preset number of fisheye features, the tracked feature points are used as the previous frame fisheye feature points of the previous frame fisheye image.

In one embodiment, after the step in S2132 is performed, as shown in FIG. 6, the method may further include:

S2134: If the number of feature points tracked on the previous frame fisheye image is less than the preset number of fisheye feature points, determine the number of compensating feature points of the previous frame fisheye image according to the number of feature points tracked on the previous frame fisheye image and the preset number of fisheye feature points.

In an embodiment of the present application, for any previous frame fisheye image in an image sequence, it can be determined whether the number of feature points tracked on the previous frame fisheye image is less than a preset number of fisheye feature points. If so, feature point compensation extraction can be performed on the previous frame fisheye image so that the number of previous frame fisheye feature points of the previous frame fisheye image is equal to the preset number of fisheye feature points.

In one embodiment, the computer device can obtain the number of compensated feature points of the previous frame fisheye image by subtracting the number of feature points tracked on the previous frame fisheye image from the preset number of fisheye features point.

For example, if the number of tracked feature points on the previous frame fisheye image is a, and the preset number of fisheye feature points is Th_{ƒ}, then the number of compensated feature points of the previous frame fisheye image may be equal to Th_{ƒ}−a.

S2135: Performing feature point compensation extraction on the previous frame fisheye image according to the number of compensated feature points of the previous frame fisheye image to obtain the previous frame fisheye feature points of the previous frame fisheye image.

Furthermore, a feature point extraction algorithm may be used to extract feature points of the number of compensation feature points from the previous frame fisheye image, so as to complete feature point compensation extraction of the previous frame fisheye image and obtain the previous frame fisheye feature points of the previous frame fisheye image.

The technical solution in some embodiments of the present application can obtain the fisheye feature points of the previous frame fisheye images captured by the fisheye camera, and track the inter-frame feature points of the current frame fisheye image based on the previous frame fisheye feature points, so as to improve the accuracy of the current frame fisheye feature points of the current frame fisheye image finally obtained; at the same time, the method does not require complex algorithms to be implemented, and the process is relatively simple, thereby improving the speed of inter-frame feature point tracking.

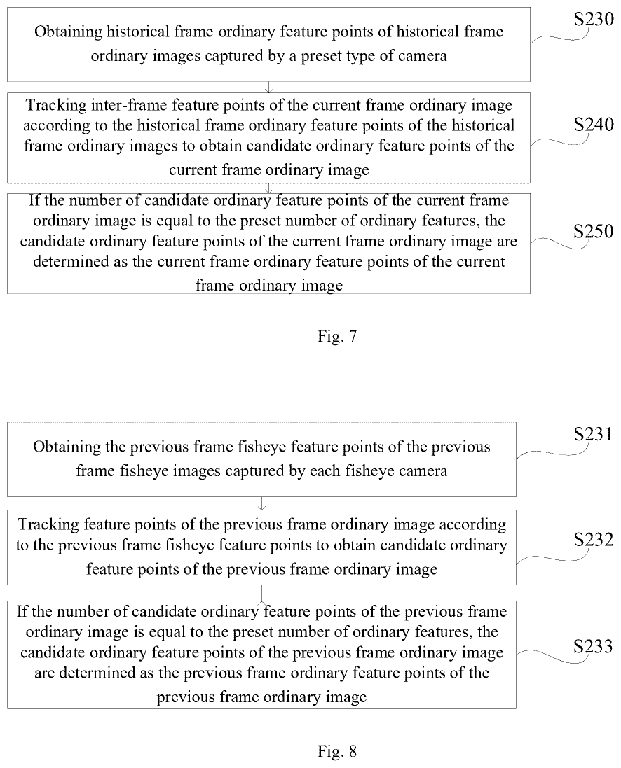

The process of tracking the feature points of the current frame ordinary image to obtain the current frame ordinary feature points of the current frame ordinary image is described below. In one embodiment, as shown in FIG. 7, the step of tracking the feature points of the current frame ordinary image to obtain the current frame ordinary feature points of the current frame ordinary image in S200 can be implemented in the following manner:

S230: obtaining historical frame ordinary feature points of historical frame ordinary images captured by a preset type of camera.

The above-mentioned historical frame ordinary images may include any multiple frames of ordinary images before the current frame. For example, the historical frame ordinary image may include any two frames of ordinary images, any three frames of ordinary images, any four frames of ordinary images, etc. before the current frame.

In practical applications, the historical frame ordinary images collected by the preset type of camera can be stored in a local location, a cloud location, a disk or a hard disk, etc. Correspondingly, the computer device can obtain the historical frame ordinary images collected by the preset type of camera from a local location, a cloud location, a disk or a hard disk, etc., and then use a feature point extraction algorithm to extract feature points of the historical frame ordinary images to obtain feature points of the historical frame ordinary images, that is, the historical frame ordinary feature points of the historical frame ordinary images.

S240: tracking inter-frame feature points of the current frame ordinary image according to the historical frame ordinary feature points of the historical frame ordinary images to obtain candidate ordinary feature points of the current frame ordinary image.

In practical applications, the computer device may use a feature point tracking algorithm to track the inter-frame feature points of the current frame ordinary image based on the historical frame ordinary feature points, and obtain the current frame ordinary feature points of the current frame ordinary image.

S250: If the number of candidate ordinary feature points of the current frame ordinary image is equal to the preset number of ordinary features, the candidate ordinary feature points of the current frame ordinary image are determined as the current frame ordinary feature points of the current frame ordinary image.

Among them, the computer device can determine whether the number of candidate ordinary feature points of the current frame ordinary image is equal to the preset number of ordinary features. If so, the candidate ordinary feature points of the current frame ordinary image are determined as the current frame ordinary feature points of the current frame ordinary image.

Optionally, the above-mentioned preset number of ordinary features can be user-defined or determined by historical experience values, but in one embodiment of the present application, the preset number of ordinary features can be equal to the maximum number of feature points of an ordinary image.

At the same time, after the step in S240 is executed, the method may further include: if the number of candidate ordinary feature points of the current frame ordinary image is less than the preset number of ordinary feature points, tracking the feature points of the current frame ordinary image according to the historical frame ordinary feature points of the historical frame ordinary images captured by the preset type of camera, and determining the current frame ordinary feature points of the current frame ordinary image.

In an embodiment of the present application, for the current frame ordinary image, if it is determined that the number of candidate ordinary feature points of the current frame ordinary image is less than the preset number of ordinary feature points, the historical frame ordinary feature points of the historical frame ordinary images captured by a preset type of camera can be obtained, and then a feature point tracking algorithm is used to track the feature points of the current frame ordinary image based on the historical frame ordinary feature points of the historical frame ordinary images to obtain the current frame ordinary feature points of the current frame ordinary image.

The historical frame ordinary feature points of the historical frame ordinary image may be obtained by extracting feature points from a previous frame ordinary image using a feature point extraction algorithm.

In one embodiment, the camera system includes at least one fisheye camera; if the historical frame fisheye image includes a previous frame fisheye image of the current frame fisheye image, the historical frame ordinary image includes a previous frame ordinary image of the current frame ordinary image, and the previous frame fisheye image is an initial frame fisheye image, and the previous frame ordinary image is an initial frame ordinary image, then as shown in FIG. 8, the step of obtaining the historical frame ordinary feature points of the historical frame ordinary image acquired by the preset type of camera in the above S230 can be implemented in the following manner:

S231: obtaining the previous frame fisheye feature points of the previous frame fisheye images captured by each fisheye camera.

In an embodiment of the present application, the camera system may include at least one fisheye camera. Specifically, the computer device may obtain the previous frame fisheye images captured by each fisheye camera from a local location, a cloud, a disk, or a hard disk.

In practical applications, the sizes of fisheye images captured by different fisheye cameras may be equal or unequal, which is not limited in the embodiments of the present application.

The computer device may use a feature point extraction algorithm to extract feature points from each previous frame fisheye image to obtain the previous frame fisheye feature points of each previous frame fisheye image.

S232: tracking feature points of the previous frame ordinary image according to the previous frame fisheye feature points to obtain candidate ordinary feature points of the previous frame ordinary image.

When the previous frame ordinary image is an initial frame ordinary image, the initial frame ordinary image can be understood as an ordinary image captured by a preset type of camera at an initial moment during the camera system shooting process.

Optionally, based on the previous frame fisheye feature points of each previous frame fisheye image obtained in the previous steps, a feature point tracking algorithm can be used to track the feature points of the previous frame ordinary image according to the previous frame fisheye feature points to obtain candidate ordinary feature points of the previous frame ordinary image.

S233: If the number of candidate ordinary feature points of the previous frame ordinary image is equal to the preset number of ordinary features, the candidate ordinary feature points of the previous frame ordinary image are determined as the previous frame ordinary feature points of the previous frame ordinary image.

In an embodiment of the present application, if the previous frame ordinary image is not the initial frame ordinary image, the method for obtaining the previous frame ordinary feature points of the previous frame ordinary image may include obtaining the ordinary feature points of the ordinary image at the previous moment corresponding to the previous frame ordinary image, and based on the ordinary feature points of the ordinary image at the previous moment corresponding to the previous frame ordinary image, performing inter-frame feature point tracking on the previous frame ordinary image to obtain candidate ordinary feature points of the previous frame ordinary image, and if the number of candidate ordinary feature points of the previous frame ordinary image is equal to the preset number of ordinary feature points, the candidate ordinary feature points of the previous frame ordinary image are determined as the previous frame ordinary feature points of the previous frame ordinary image.

It can be understood that, except for the initial frame ordinary image, the method of obtaining the ordinary feature points of each other frame ordinary image includes tracking the inter-frame feature points of the other previous frame ordinary images according to the ordinary feature points of the previous frame ordinary images corresponding to the ordinary image of the previous moment, and obtain the candidate ordinary feature points of the other previous frame ordinary images. If the number of candidate ordinary feature points of the other frame ordinary images is equal to the preset number of ordinary feature points, the candidate ordinary feature points of the other frame ordinary images are determined as the ordinary feature points of the other previous frame ordinary images.

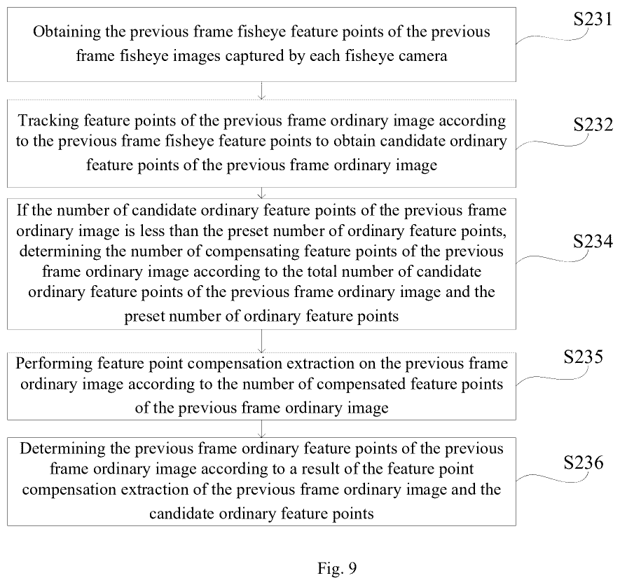

In one embodiment, after the step in S232 is performed, as shown in FIG. 9, the method may further include:

S234: If the number of candidate ordinary feature points of the previous frame ordinary image is less than the preset number of ordinary feature points, determining the number of compensating feature points of the previous frame ordinary image according to the total number of candidate ordinary feature points of the previous frame ordinary image and the preset number of ordinary feature points.

In an embodiment of the present application, when it is determined that the number of candidate ordinary feature points of the previous frame ordinary image is less than the preset number of ordinary feature points, the feature points of the previous frame ordinary image can be compensated so that the number of ordinary feature points of the previous frame ordinary image is equal to the preset number of ordinary feature points.

Optionally, the computer device may obtain the number of compensated feature points of the previous frame ordinary image by subtracting the total number of candidate ordinary feature points of the previous frame ordinary image from the preset number of ordinary feature points.

For example, if the number of feature points extracted from the previous frame ordinary image is b, and the preset number of ordinary feature points is Thₚ, then the number of compensated feature points of the previous frame ordinary image may be equal to Thₚ−b.

S235: performing feature point compensation extraction on the previous frame ordinary image according to the number of compensated feature points of the previous frame ordinary image.

Furthermore, a feature point extraction algorithm may be used to perform feature point compensation extraction on the previous frame ordinary image, and a number of feature points equal to the number of compensated feature points may be extracted from the previous frame ordinary image.

S236: determining the previous frame ordinary feature points of the previous frame ordinary image according to a result of the feature point compensation extraction of the previous frame ordinary image and the candidate ordinary feature points.

In practical applications, the number of feature points of compensated feature points extracted from the previous frame ordinary image (ie, feature point compensation extraction results) and candidate ordinary feature points can be determined as the previous frame ordinary feature points of the previous frame ordinary image.

The technical solution in one embodiment of the present application can obtain the previous frame ordinary feature points of the previous frame ordinary image captured by a preset type of camera, and track the inter-frame feature points of the current frame ordinary image based on the previous frame ordinary feature points of the previous frame ordinary image to obtain candidate ordinary feature points of the current frame ordinary image. When the number of candidate ordinary feature points of the current frame ordinary image is equal to the preset number of ordinary feature points, the candidate ordinary feature points of the current frame ordinary image are determined as the current frame ordinary feature points of the current frame ordinary image, so that the current frame fisheye feature points of the current frame fisheye image finally obtained are more accurate. At the same time, the method does not require complex algorithms to be implemented, and the process is relatively simple, thereby improving the speed of inter-frame feature point tracking.

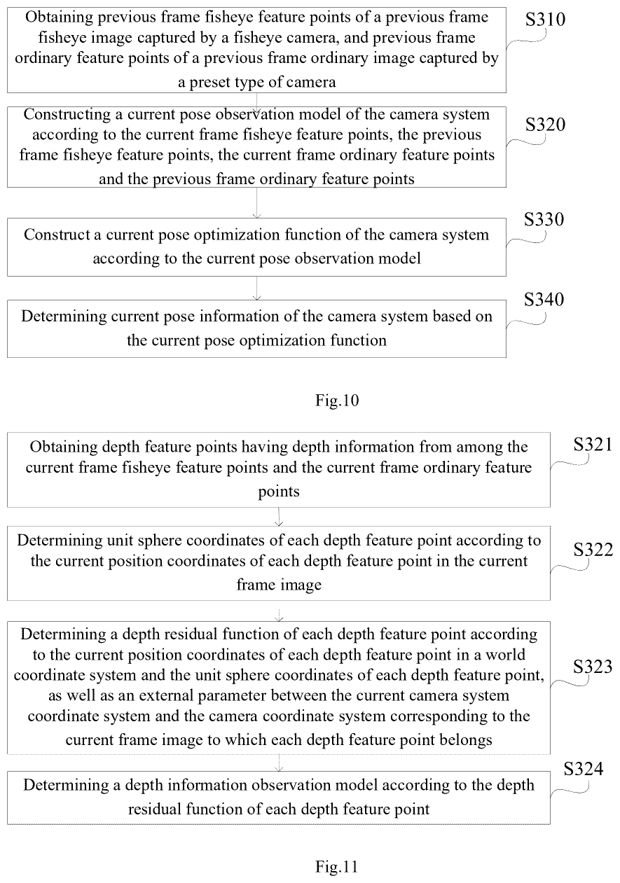

The following is an explanation of the process of determining the current pose information of the camera system based on the current frame fisheye feature points and the current frame ordinary feature points. In one embodiment, as shown in FIG. 10, the steps in S300 above can be implemented in the following manner:

S310: obtaining previous frame fisheye feature points of a previous frame fisheye image captured by a fisheye camera, and previous frame ordinary feature points of a previous frame ordinary image captured by a preset type of camera.

The computer device may obtain previous frame fisheye feature points of a previous frame fisheye image captured by a predetermined fisheye camera, and previous frame ordinary feature points of a previous frame ordinary image captured by a preset type of camera.

In addition, the computer device can also obtain the previous frame fisheye image captured by the fisheye camera and the previous frame ordinary image captured by a preset type camera from a local location, a cloud location, a disk or a hard disk, and then use a feature point extraction algorithm to extract feature points from the previous frame fisheye image to obtain the previous frame fisheye feature points of the previous frame fisheye image; at the same time, a feature point extraction algorithm can also be used to extract feature points from the previous frame ordinary image to obtain the previous frame ordinary feature points of the previous frame ordinary image.

S320: constructing a current pose observation model of the camera system according to the current frame fisheye feature points, the previous frame fisheye feature points, the current frame ordinary feature points and the previous frame ordinary feature points.

Optionally, the computer device can use a pose estimation algorithm to perform pose estimation processing on the current frame fisheye feature points, the previous frame fisheye feature points, the current frame ordinary feature points and the previous frame ordinary feature points to obtain the current pose observation model of the camera system.

Optionally, the above-mentioned pose estimation algorithm can be a model-based pose estimation algorithm, a feature-based pose estimation algorithm, or a deep learning-based camera pose estimation algorithm, etc., which is not limited to this embodiment of the present application.

In one embodiment, the current pose observation model includes a depth information observation model and a non-depth information observation model; the step of constructing the current pose observation model of the camera system according to the current frame fisheye feature points, the previous frame fisheye feature points, the current frame ordinary feature points and the previous frame ordinary feature points in the above S320 can be implemented in the following way: determining the depth information observation model according to the current frame fisheye feature points and the current frame ordinary feature points; and constructing the non-depth information observation model according to the current frame fisheye feature points, the previous frame fisheye feature points, the current frame ordinary feature points and the previous frame ordinary feature points.

In one embodiment of the present application, the computer device may obtain some or all feature points from the current frame fisheye feature points and the current frame ordinary feature points, and then process the obtained feature points to obtain the depth information observation model. Alternatively, the computer device may directly process the current frame fisheye feature points and the current frame ordinary feature points according to the construction strategy of the depth information observation model to obtain the depth information observation model.

At the same time, the computer device can obtain some or all feature points from the current frame fisheye feature points, the previous frame fisheye feature points, the current frame ordinary feature points and the previous frame ordinary feature points, and then process the obtained feature points to obtain a non-depth information observation model. Alternatively, the computer device can also directly process the current frame fisheye feature points, the previous frame fisheye feature points, the current frame ordinary feature points and the previous frame ordinary feature points according to the construction strategy of the non-depth information observation model to obtain a non-depth information observation model.

S330: construct a current pose optimization function of the camera system according to the current pose observation model.

In one embodiment of the present application, there may be multiple current pose observation models. Based on the current pose observation model obtained in the previous steps, an arithmetic operation can be performed on the current pose observation model to obtain a current pose optimization function of the camera system.

Optionally, the arithmetic operation may be at least one of addition, subtraction, multiplication, division, logarithmic operation and exponential operation.

S340: determining current pose information of the camera system based on the current pose optimization function.

In practical applications, the computer device can use an optimization algorithm to solve the current pose optimization function to obtain the current pose information of the camera system. Optionally, the above-mentioned optimization algorithm can be a gradient descent method, a Newton method, a conjugate gradient method and/or a genetic algorithm, etc. In the embodiment of the present application, the above-mentioned optimization algorithm can be a least squares method, and the least squares method can be a Levenberg-Marquardt method or a Gauss-Newton iteration method, etc.

The technical solution in one embodiment of the present application obtains the previous frame fisheye feature points of the previous frame fisheye image captured by the fisheye camera, and the previous frame ordinary feature points of the previous frame ordinary image captured by the preset type camera, and constructs a current pose observation model of the camera system according to the current frame fisheye feature points, the previous frame fisheye feature points, the current frame ordinary feature points and the previous frame ordinary feature points, and constructs a current pose optimization function of the camera system according to the current pose observation model, and determines the current pose information of the camera system based on the current pose optimization function; the method can construct the current pose observation model of the camera system through the feature points of adjacent frame images, so that the constructed current pose observation model of the camera system is more accurate, and on this basis, the current pose information of the camera system can also be accurately determined.

In one embodiment, as shown in FIG. 11, the step of determining the depth information observation model according to the current frame fisheye feature points and the current frame ordinary feature points can be implemented in the following manner:

S321: obtaining depth feature points having depth information from among the current frame fisheye feature points and the current frame ordinary feature points; the depth feature points include three-dimensional position coordinates of the feature points.

In practical applications, the computer device may filter feature points having depth information, i.e. depth feature points, from the current frame fisheye feature points and the current frame ordinary feature points.

It should be noted here that the current frame fisheye feature points may be feature points with depth information, and the current frame ordinary feature points may also be feature points with depth information.

S322: determining unit sphere coordinates of each depth feature point according to the current position coordinates of each depth feature point in the current frame image.

Optionally, the current frame image to which the depth feature point belongs may be a current frame fisheye image or a current frame ordinary image. Optionally, the current position coordinates of the depth feature point may be understood as the position coordinates corresponding to the depth feature point in the current frame image.

Among them, for any depth feature point, the current position coordinates of the depth feature point in the current frame image can be obtained according to the result of feature point extraction on the current frame image, and then the current position coordinates of the depth feature point in the current frame image can be converted to obtain the unit sphere coordinates of the depth feature point.

S323: determining a depth residual function of each depth feature point according to the current position coordinates of each depth feature point in a world coordinate system and the unit sphere coordinates of each depth feature point, as well as an external parameter between the current camera system coordinate system and the camera coordinate system corresponding to the current frame image to which each depth feature point belongs.

Among them, the camera coordinate system corresponding to the current frame image to which the above-mentioned depth feature points belong can be understood as the coordinate system corresponding to the camera that collects the current frame image to which the depth feature points belong. It should be noted here that if the current frame image is a current frame fisheye image, the camera of the current frame image can be a fisheye camera that collects the current frame image; if the current frame image is a current frame ordinary image, the camera of the current frame image can be a preset type of camera that collects the current frame image.

Optionally, the above-mentioned camera system coordinate system refers to a coordinate system created based on all cameras in the camera system. In the embodiment of the present application, the camera system coordinate system may be the same or different at different times, and the embodiment of the present application is not limited to this.

Optionally, the computer device can perform arithmetic operations on the current position coordinates of each depth feature point in the world coordinate system and the unit sphere coordinates of each depth feature point, as well as the external parameter between the current camera system coordinate system and the camera coordinate system corresponding to the current frame image to which each depth feature point belongs, to obtain the depth residual function of each depth feature point.

For the convenience of calculation, the camera system coordinate system corresponding to the initial frame can be used as the world coordinate system. At the same time, the above external parameter can include a rotation matrix and a translation vector.

In an embodiment of the present application, if the camera system includes m (m is greater than or equal to 1) fisheye cameras, the m fisheye cameras C_{ƒ} can be respectively expressed as C_{ƒ1} [symbol] C_{ƒ2} [symbol] . . . [symbol] C_{ƒk} [symbol] . . . [symbol] C_{ƒm}, k is greater than or equal to 1 and less than or equal to m, and
correspondingly, the current frame fisheye image collected by the m fisheye cameras can be expressed as the F_{ƒ1}^{c} [symbol] F_{ƒ2}^{c} [symbol] F_{ƒk}^{c} [symbol] . . . [symbol] F_{ƒm}^{c}, and the previous frame fisheye image collected by the m fisheye cameras can be expressed as the F_{ƒ1}^{l} [symbol] F_{ƒ2}^{l} [symbol] . . . [symbol] F_{ƒk}^{l} [symbol] . . . [symbol] F_{ƒm}^{l}. At the same time, the camera system includes n (n is greater than or equal to 1) preset type of cameras, the n preset type of cameras Cₚ can be respectively expressed as Cₚ₁ [symbol] Cₚ₂ [symbol] . . . [symbol] Cₚₒ [symbol] . . . [symbol] Cₚₘ, o is greater than or equal to 1 and less than or equal to n, and correspondingly, the current frame ordinary image collected by the n preset type cameras can be expressed as Fₚ₁^{c} [symbol] Fₚ₂^{c} [symbol] . . . [symbol] Fₚₒ^{c} [symbol] . . . [symbol] Fₚₙ^{c}, and the previous frame ordinary image collected by the n preset type cameras can be expressed as Fₚ₁^{l} [symbol] Fₚ₂^{l} [symbol] . . . [symbol] Fₚₒ^{l} [symbol] . . . [symbol] Fₚₙ^{l}, and each depth feature point is respectively expressed as P₁₁ [symbol] P₁₂ [symbol] . . . [symbol] P₁ₐ. In one embodiment of the present application, for the depth feature point P₁ₐ, the depth residual function ƒ₁ₐ(R_{Bc}^{W}, t_{Bc}^{W}) of the depth feature point P₁ₐ can be constructed by the following formula (1).

$${f}_{1 a} ( {R}_{Bc}^{W} , {t}_{Bc}^{W} ) = \frac{{{R}_{B}^{Cm} ( {R}_{Bc}^{W} )}^{T} ( {X}_{a}^{W} - {t}_{Bc}^{W} ) + {t}_{B}^{Cm}}{\vert {{R}_{B}^{Cm} ( {R}_{Bc}^{W} )}^{T} ( {X}_{a}^{W} - {t}_{Bc}^{W} ) + {t}_{B}^{Cm} \vert} - \qquad ( 1 )$$

Among them, Xₐ^{W} in formula (1) represents the current position coordinates of the depth feature point P₁ₐ in the world coordinate system, [symbol] represents the unit sphere coordinates of the depth feature point P₁ₐ, R_{B}^{Cm} and t_{B}^{Cm} represents the respective external parameters (i.e., the rotation matrix and the translation vector) between the current camera system coordinate system and the camera coordinate system corresponding to the current frame image to which the depth feature point P₁ₐ belongs.

S324: determining a depth information observation model according to the depth residual function of each depth feature point.

Furthermore, the depth residual function of each depth feature point can be subjected to arithmetic operations to obtain a depth information observation model. In an embodiment of the present application, the second norm of the depth residual function of each depth feature point can be calculated, and then the second norm of the depth residual function of each depth feature point can be squared, and then the squares of the second norms of the depth residual function of each depth feature point can be summed to obtain the depth information observation model.

In one embodiment of the present application, if the depth information observation model represents F₁, then F₁ can be expressed by the following formula (2).

$${F}_{1} = {\sum }_{a} {‖ {f}_{1 a} ( {R}_{Bc}^{W} , {t}_{Bc}^{W} ) ‖}^{2} \qquad ( 2 )$$

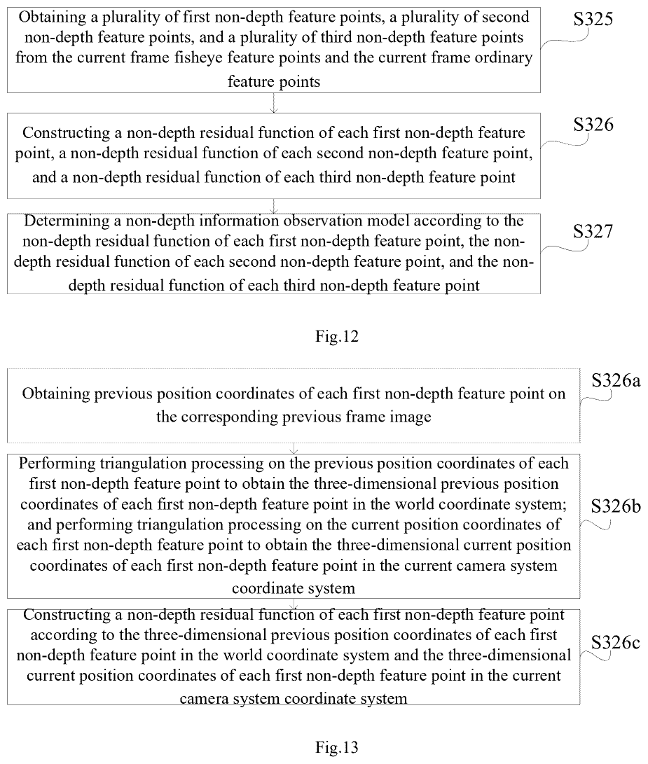

At the same time, in one embodiment, as shown in FIG. 12, the step of constructing a non-depth information observation model based on the current frame fisheye feature points, the previous frame fisheye feature points, the current frame ordinary feature points, and the previous frame ordinary feature points can be implemented in the following manner:

S325: obtaining a plurality of first non-depth feature points, a plurality of second non-depth feature points, and a plurality of third non-depth feature points from the current frame fisheye feature points and the current frame ordinary feature points.

In one embodiment of the present application, the non-depth feature point screening conditions for screening the first non-depth feature point, the second non-depth feature point, and the third non-depth feature point are different.

In practical applications, the computer device may use different non-depth feature point screening conditions to screen a plurality of first non-depth feature points, a plurality of second non-depth feature points and a plurality of third non-depth feature points from the current frame fisheye feature points and the current frame ordinary feature points.

S326: constructing a non-depth residual function of each first non-depth feature point, a non-depth residual function of each second non-depth feature point, and a non-depth residual function of each third non-depth feature point.

Optionally, for any first non-depth feature point, the computer device may perform arithmetic operation and/or coordinate conversion processing on the current position coordinates of the first non-depth feature point to obtain the non-depth residual function of the first non-depth feature point.

Optionally, for any second non-depth feature point, the computer device may perform arithmetic operation and/or coordinate conversion processing on the current position coordinates of the second non-depth feature point to obtain the non-depth residual function of the second non-depth feature point.

Optionally, for any third non-depth feature point, the computer device may perform arithmetic operation and/or coordinate conversion processing on the current position coordinates of the third non-depth feature point to obtain the non-depth residual function of the third non-depth feature point.

In one embodiment of the present application, the construction methods of the non-depth residual function of each first non-depth feature point, the non-depth residual function of each second non-depth feature point, and the non-depth residual function of each third non-depth feature point may be the same or different.

S327: determining a non-depth information observation model according to the non-depth residual function of each first non-depth feature point, the non-depth residual function of each second non-depth feature point, and the non-depth residual function of each third non-depth feature point.

Among them, the computer device can perform arithmetic operations on the non-depth residual function of each first non-depth feature point to obtain a corresponding non-depth information observation model. In an embodiment of the present application, the second norm of the non-depth residual function of each first non-depth feature point can be calculated, and then the second norm of the non-depth residual function of each first non-depth feature point can be squared, and then the squares of the second norms of the non-depth residual function of each first non-depth feature point can be summed to obtain the corresponding non-depth information observation model.

At the same time, the computer device can perform arithmetic operations on the non-depth residual function of each second non-depth feature point to obtain a corresponding non-depth information observation model. In an embodiment of the present application, the second norm of the non-depth residual function of each second non-depth feature point can be calculated, and then the second norm of the non-depth residual function of each second non-depth feature point can be squared, and then the squares of the second norms of the non-depth residual function of each second non-depth feature point can be summed to obtain the corresponding non-depth information observation model.

In addition, the computer device can perform arithmetic operations on the non-depth residual function of each third non-depth feature point to obtain a corresponding non-depth information observation model. In an embodiment of the present application, the second norm of the non-depth residual function of each third non-depth feature point can be calculated, and then the second norm of the non-depth residual function of each third non-depth feature point can be squared, and then the squares of the second norms of the non-depth residual function of each third non-depth feature point can be summed to obtain the corresponding non-depth information observation model.

In an embodiment of the present application, each first non-depth feature point represents a current frame feature point without depth information that is in at least two current frame images and in at least two previous frame images; each second non-depth feature point represents a current frame feature point without depth information that is only in one current frame image and in at least two previous frame images; each third non-depth feature point represents a current frame feature point without depth information that is in at least two current frame images and in only one previous frame image; wherein the current frame image is either a current frame fisheye image or a current frame ordinary image; and the previous frame image is either a previous frame fisheye image or a previous frame ordinary image.

It should be noted that the camera system may include multiple fisheye cameras and multiple preset type of cameras. Correspondingly, the computer device may obtain multiple current frame fisheye images and multiple current frame ordinary images, and then obtain the current frame fisheye feature points of each current frame fisheye image and the current frame ordinary feature points of each current frame ordinary image, and then first filter out all current frame feature points without depth information from all current frame fisheye feature points and all current frame ordinary feature points.

Furthermore, based on all the acquired current frame feature points without depth information, for each current frame feature point without depth information, it can be determined whether the current frame feature point without depth information is in at least two current frame images and in at least two previous frame images. If so, the current frame feature point without depth information is determined as the first non-depth feature point.

For each current frame feature point without depth information, it is also possible to determine whether the current frame feature point without depth information is only in one current frame image and in at least two previous frame images. If so, the current frame feature point without depth information is determined as the second non-depth feature point.

For each current frame feature point without depth information, it can also be determined whether the current frame feature point without depth information is in at least two current frame images and only in one previous frame image. If so, the current frame feature point without depth information is determined as the third non-depth feature point.

The embodiment of the present application can obtain non-depth feature points with non-depth information, and then determine the corresponding non-depth information observation model according to each non-depth feature point, and use the non-depth information observation model as basic information to provide a reference basis for accurately determining the current pose information of the camera system.

The technical solution in some embodiments of the present application obtains depth feature points with depth information from the current frame fisheye feature points and the current frame ordinary feature points, determines the unit spherical coordinates of each depth feature point according to the current position coordinates of each depth feature point in the current frame image to which it belongs, determines the depth residual function of each depth feature point according to the current position coordinates of each depth feature point in the world coordinate system and the unit spherical coordinates of each depth feature point, and the external parameter between the current camera system coordinate system and the camera coordinate system corresponding to the current frame image to which each depth feature point belongs, and determines the depth information observation model according to the depth residual function of each depth feature point; the method can obtain depth feature points with depth information, and then determine the corresponding depth information observation model according to each depth feature point, and use the depth information observation model as basic information to provide a reference basis for accurately determining the current pose information of the camera system.

The process of constructing the non-depth residual function of each first non-depth feature point is described below. In one embodiment, as shown in FIG. 13, the step of constructing the non-depth residual function of each first non-depth feature point in S326 can be implemented in the following manner:

S326a: obtaining previous position coordinates of each first non-depth feature point on the corresponding previous frame image.

Optionally, the previous position coordinates of each first non-depth feature point on the corresponding previous frame image may be obtained according to the result of feature point extraction of each first non-depth feature point on the corresponding previous frame image.

It should be noted here that the previous position coordinates of the first non-depth feature point can be understood as the position coordinates of the first non-depth feature point on the previous frame image.

S326b: performing triangulation processing on the previous position coordinates of each first non-depth feature point to obtain the three-dimensional previous position coordinates of each first non-depth feature point in the world coordinate system; and performing triangulation processing on the current position coordinates of each first non-depth feature point to obtain the three-dimensional current position coordinates of each first non-depth feature point in the current camera system coordinate system.

In practical applications, the depth information of feature points can be obtained by triangulating the position coordinates of feature points.

In an embodiment of the present application, for any first non-depth feature point, the computer device can perform triangulation processing on the previous position coordinates of the first non-depth feature point to obtain the three-dimensional previous position coordinates of the first non-depth feature point in the world coordinate system; at the same time, the current position coordinates of the first non-depth feature point can also be triangulated to obtain the three-dimensional current position coordinates of the first non-depth feature point in the current camera system coordinate system.

It should be noted here that the first non-depth feature point can be in at least one current frame image, and naturally, the number of current position coordinates of the first non-depth feature point can be at least one; the first non-depth feature point can also be in at least one previous frame image, and naturally, the number of previous position coordinates of the first non-depth feature point can be at least one.

S326c: constructing a non-depth residual function of each first non-depth feature point according to the three-dimensional previous position coordinates of each first non-depth feature point in the world coordinate system and the three-dimensional current position coordinates of each first non-depth feature point in the current camera system coordinate system.

Among them, for any first non-depth feature point, arithmetic operations can be performed on the three-dimensional previous position coordinates of the first non-depth feature point in the world coordinate system and the three-dimensional current position coordinates of the first non-depth feature point in the current camera system coordinate system to obtain the non-depth residual function of the first non-depth feature point.

In one embodiment of the present application, referring to the previous example, if each first non-depth feature point is represented as P₂₁ [symbol] P₂₂ [symbol] . . . [symbol] P_{2b} respectively, for the first non-depth feature point P_{2b}, the depth residual function of ƒ_{2b}(R_{Bc}^{W}, t_{Bc}^{W}) of the first non-depth feature point P_{2b} can be constructed by the following formula (3).

$${f}_{2 b} ( {R}_{Bc}^{W} , {t}_{Bc}^{W} ) = {( {R}_{Bc}^{W} )}^{T} ( - {t}_{Bc}^{W} ) - \qquad ( 3 )$$

Wherein, [symbol] in formula (3) represents the three-dimensional previous position coordinates of the first non-depth feature point P_{2b} in the world coordinate system, [symbol] represents the three-dimensional current position coordinates of the first non-depth feature point P_{2b} in the current camera system coordinate system.

Furthermore, the non-depth information observation model determined according to the depth residual function of ƒ_{2b}(R_{Bc}^{W}, t_{Bc}^{W}) of the first non-depth feature point P_{2b} can be expressed by the following formula (4).

$${F}_{2} = {\sum }_{b} {‖ {f}_{2 b} ( {R}_{Bc}^{W} , {t}_{Bc}^{W} ) ‖}^{2} \qquad ( 4 )$$

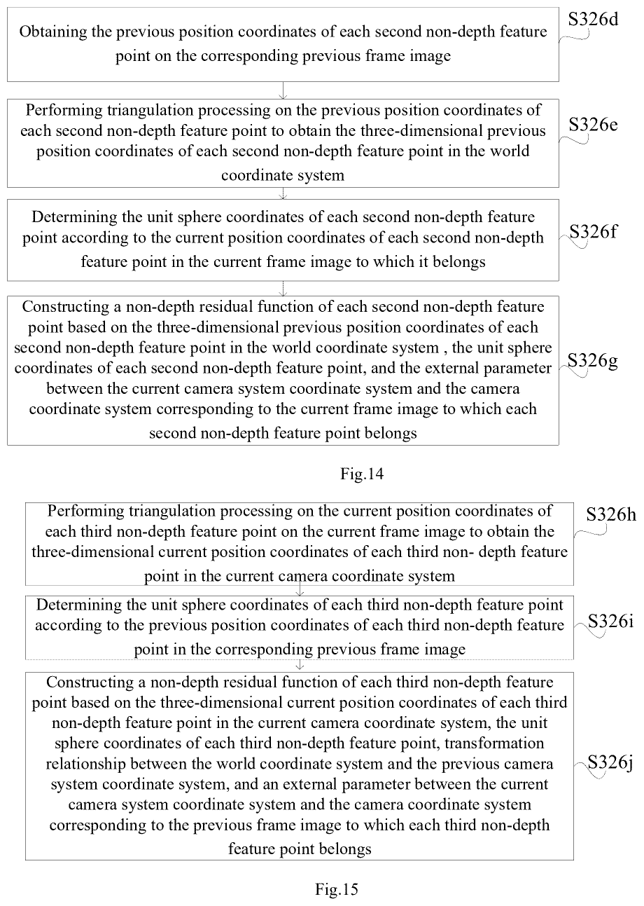

Meanwhile, in another embodiment, as shown in FIG. 14, the step of constructing the non-depth residual function of each second non-depth feature point in S326 can be implemented in the following manner:

S326d: obtaining the previous position coordinates of each second non-depth feature point on the corresponding previous frame image.

Optionally, the previous position coordinates of each second non-depth feature point on the corresponding previous frame image may be obtained according to the result of feature point extraction on each previous frame image.

It should be noted here that the previous position coordinates of the second non-depth feature point can be understood as the position coordinates of the second non-depth feature point on the previous frame image.

S326e: performing triangulation processing on the previous position coordinates of each second non-depth feature point to obtain the three-dimensional previous position coordinates of each second non-depth feature point in the world coordinate system.

In the embodiment of the present application, for any second non-depth feature point, the computer device can triangulate the previous position coordinates of the second non-depth feature point to obtain the three-dimensional previous position coordinates of the second non-depth feature point in the world coordinate system.

It should be noted here that the second non-depth feature point may be in at least one previous frame image, and naturally, the number of previous position coordinates of the second non-depth feature point may be at least one.

S326f: determining the unit sphere coordinates of each second non-depth feature point according to the current position coordinates of each second non-depth feature point in the current frame image to which it belongs.

Optionally, the current frame image to which the second non-depth feature point belongs may be a current frame fisheye image or a current frame ordinary image. Optionally, the current position coordinates of the second non-depth feature point may be understood as the position coordinates corresponding to the second non-depth feature point in the current frame image.

Among them, for any second non-depth feature point, the current position coordinates of the second non-depth feature point in the current frame image can be obtained based on the result of feature point extraction on the current frame image, and then the current position coordinates of the second non-depth feature point in the current frame image can be converted to obtain the unit sphere coordinates of the second non-depth feature point.

S326g: constructing a non-depth residual function of each second non-depth feature point based on the three-dimensional previous position coordinates of each second non-depth feature point in the world coordinate system, the unit sphere coordinates of each second non-depth feature point, and the external parameter between the current camera system coordinate system and the camera coordinate system corresponding to the current frame image to which each second non-depth feature point belongs.

Optionally, for any second non-depth feature point, arithmetic operations can be performed on the three-dimensional previous position coordinates of the second non-depth feature point in the world coordinate system, the unit sphere coordinates of the second non-depth feature point, and the external parameter between the current camera system coordinate system and the camera coordinate system corresponding to the current frame image to which the second non-depth feature point belongs to obtain the non-depth residual function of the second non-depth feature point.

In one embodiment of the present application, referring to the previous example, if each second non-depth feature point is represented as P₃₁ [symbol] P₃₂ [symbol] . . . [symbol] P_{3c} respectively, for the second non-depth feature point P_{3c}, the depth residual function of the ƒ_{3c}(R_{Bc}^{W}, t_{Bc}^{W}) of the second non-depth feature point P_{3c} can be constructed by the following formula (5).

$${f}_{3 c} ( {R}_{Bc}^{W} , {t}_{Bc}^{W} ) = \frac{{{R}_{B}^{Cn} ( {R}_{Bc}^{W} )}^{T} ( \hat{{X}_{c}^{W}} - {t}_{Bc}^{W} ) + {t}_{B}^{Cn}}{\vert {{R}_{B}^{Cn} ( {R}_{Bc}^{W} )}^{T} ( \hat{{X}_{c}^{W}} - {t}_{Bc}^{W} ) + {t}_{B}^{Cn} \vert} - \qquad ( 5 )$$

Wherein, [symbol] in formula (5) represents the three-dimensional previous position coordinates of the second non-depth feature point P_{3c} in the world coordinate system, [symbol] represents the unit spherical coordinates of R_{B}^{Cn} of the second non-depth feature point P_{3c}, and t_{B}^{Cn} represents the external parameter between the current camera system coordinate system and the camera coordinate system corresponding to the current frame image to which the second non-depth feature point P_{3c} belongs.

Furthermore, the non-depth information observation model determined according to the depth residual function of the ƒ_{3c}(R_{Bc}^{W}, t_{Bc}^{W}) of the second non-depth feature point P_{3c} can be expressed by the following formula (6).

$${F}_{3} = {\sum }_{c} {‖ {f}_{3 c} ( {R}_{Bc}^{W} , {t}_{Bc}^{W} ) ‖}^{2} \qquad ( 6 )$$

In addition, in one embodiment, as shown in FIG. 15, the step of constructing the non-depth residual function of each third non-depth feature point in S326 can be implemented in the following manner:

S326h: performing triangulation processing on the current position coordinates of each third non-depth feature point on the current frame image to obtain the three-dimensional current position coordinates of each third non-depth feature point in the current camera coordinate system.

Optionally, the current position coordinates of the third non-depth feature point may be understood as the position coordinates of the third non-depth feature point on the current frame image.

In actual applications, the computer device can obtain the current position coordinates of each third non-depth feature point on the current frame image to which it belongs, and then for any third non-depth feature point, the current position coordinates of the third non-depth feature point on the current frame image to which it belongs can be triangulated to obtain the three-dimensional current position coordinates of the third non-depth feature point in the current camera coordinate system.

S326i: determining the unit sphere coordinates of each third non-depth feature point according to the previous position coordinates of each third non-depth feature point in the corresponding previous frame image.

Optionally, the previous frame image to which the third non-depth feature point belongs can be a previous frame fisheye image or a previous frame ordinary image. Optionally, the previous position coordinates of the third non-depth feature point can be understood as the position coordinates corresponding to the third non-depth feature point in the previous frame image.

Among them, for any third non-depth feature point, the previous position coordinates of the third non-depth feature point in the previous frame image can be obtained based on the result of feature point extraction on the previous frame image, and then the previous position coordinates of the third non-depth feature point in the previous frame image can be converted to obtain the unit sphere coordinates of the third non-depth feature point.

S326j: constructing a non-depth residual function of each third non-depth feature point based on the three-dimensional current position coordinates of each third non-depth feature point in the current camera coordinate system, the unit sphere coordinates of each third non-depth feature point, transformation relationship between the world coordinate system and the previous camera system coordinate system, and an external parameter between the current camera system coordinate system and the camera coordinate system corresponding to the previous frame image to which each third non-depth feature point belongs.

Optionally, for any third non-depth feature point, arithmetic operations can be performed on the three-dimensional current position coordinates of the third non-depth feature point in the current camera coordinate system, the unit sphere coordinates of the third non-depth feature point, the transformation relationship between the world coordinate system and the previous camera system coordinate system, and the external parameter between the current camera system coordinate system and the camera coordinate system corresponding to the previous frame image to which the third non-depth feature point belongs, to obtain the non-depth residual function of the third non-depth feature point.

In one embodiment of the present application, referring to the previous example, if each third non-depth feature point is represented as P₄₁ [symbol] P₄₂ [symbol] . . . [symbol] P_{4d}, for the third non-depth feature point P_{4d}, the depth residual function of ƒ_{4d}(R_{Bc}^{W}, t_{Bc}^{W}) of the third non-depth feature point P_{4d} can be constructed by the following formula (7).

$${f}_{4 d} ( {R}_{Bc}^{W} , {t}_{Bc}^{W} ) = \frac{{R}_{B}^{Cz} ( {R}_{W}^{Bl} ( {R}_{Bc}^{W} + {t}_{Bc}^{W} ) + {t}_{W}^{Bl} ) + {t}_{B}^{Cz}}{\vert {R}_{B}^{Cz} ( {R}_{W}^{Bl} ( {R}_{Bc}^{W} + {t}_{Bc}^{W} ) + {t}_{W}^{Bl} ) + {t}_{B}^{Cz} \vert} - \qquad ( 7 )$$

Among them, in formula (7), [symbol] represents the three-dimensional current position coordinates of the third non-depth feature point P_{4d} in the current camera coordinate system, [symbol] represents the unit sphere coordinates of the third non-depth feature point P_{4d}, R_{W}^{Bl} and t_{W}^{Bl} represent the transformation relationship between the world coordinate system and the previous camera system coordinate system, R_{B}^{Cz} and t_{B}^{Cz} respectively represent the external parameter between the current camera system coordinate system and the camera coordinate system corresponding to the previous frame image to which the third non-depth feature point P_{4d} belongs.

Further, the non-depth information observation model determined according to the depth residual function of the ƒ_{4d}(R_{Bc}^{W}, t_{Bc}^{W}) of the third non-depth feature point P_{4d} can be expressed by the following formula (8).

$${F}_{4} = {\sum }_{d} {‖ {f}_{3 d} ( {R}_{Bc}^{W} , {t}_{Bc}^{W} ) ‖}^{2} \qquad ( 8 )$$

It should be noted here that, in one embodiment of the present application, based on the depth information observation model F₁ corresponding to the constructed depth feature points, the non-depth information observation model F₂ corresponding to the first non-depth feature points, the non-depth information observation model F₃ corresponding to the second non-depth feature points, and the non-depth information observation model F₄ corresponding to the third non-depth feature points, the current pose optimization function of the camera system constructed can be expressed by formula (9).

$${arg min}_{{R}_{Bc}^{W} , {t}_{Bc}^{W}} \{ {F}_{1} + {F}_{2} + {F}_{3} + {F}_{4} \} \qquad ( 9 )$$

In addition, it should be noted that the computer device can obtain the previous pose information of the camera system, and perform triangulation processing on all the current frame feature points (the current frame fisheye feature points and the current frame ordinary feature points) according to the current pose information of the camera system and the previous pose information of the camera system, and obtain the three-dimensional position coordinates of each current frame feature point in the world coordinate system, in preparation for determining next pose information of the camera system at the next moment.

At the same time, feature point post-processing (i.e., feature point supplementation) can be performed on the current frame ordinary image and the current frame fisheye image. Optionally, the ordinary feature points of the current frame ordinary image are supplemented, and the fisheye feature points of the current frame fisheye image are supplemented to prepare for determining the next pose information of the camera system at the next moment.

Among them, for the current frame fisheye image F_{ƒk}^{c}, the number of fisheye feature points that need to be supplemented is A_{ƒk}, and the number of current frame fisheye feature points of currently tracked is T_{ƒk}. Among them, if T_{ƒk} is smaller than Th_{ƒ}, A_{ƒk}=Th_{ƒ}−T_{ƒk}; if T_{ƒk}=Th_{ƒ}, A_{ƒk}=0.

Optionally, each current frame fisheye image can be sorted. For the current frame fisheye image F_{ƒ1}^{c} of sorted number 1, a feature point extraction algorithm can be used to extract A_{ƒ1} feature points from the current frame fisheye image F_{ƒ1}^{c} as the fisheye feature points supplemented by the current frame fisheye image F_{ƒ1}^{c}. For the current frame fisheye image of sorted number 2 F_{ƒ2}^{c}, feature point tracking can be performed on the current frame fisheye image F_{ƒ2}^{c} based on the fisheye feature points supplemented by the current frame fisheye image F_{ƒ1}^{c}. If the number of newly tracked fisheye feature points (i.e., supplemented fisheye feature points) of the current frame fisheye image F_{ƒ2}^{c} is equal to A_{ƒk}, then the tracking of the current frame fisheye image F_{ƒ2}^{c} is terminated. If the number of newly tracked fisheye feature points of the current frame fisheye image F_{ƒ2}^{c} is less than A_{ƒk}, then A_{ƒk}−r_{ƒ2} feature points are extracted from the current frame fisheye image F_{ƒ2}^{c}, where r_{ƒ2} represents the number of newly tracked fisheye feature points of the current frame fisheye image F_{ƒ2}^{c}.

If for the current fisheye image F_{ƒ4}^{c} of sorted number 4, the feature points of the current fisheye image F_{ƒ4}^{c} can be tracked according to the current fisheye image F_{ƒ1}^{c}, the current fisheye image F_{ƒ2}^{c} and the fisheye feature points supplemented by the current fisheye image F_{ƒ2}^{c}. If the number of newly tracked fisheye feature points (i.e., supplemented fisheye feature points) of the current fisheye image F_{ƒ4}^{c} is equal to A_{ƒk}, then the tracking of current fisheye image F_{ƒ4}^{c} is terminated. If the number of newly tracked fisheye feature points of the current fisheye image F_{ƒ4}^{c} is less than A_{ƒk}, then A_{ƒk}−r_{ƒ4} feature points are extracted from the current fisheye image F_{ƒ4}^{c}, where r_{ƒ4} represents the number of newly tracked fisheye feature points of the current fisheye image F_{ƒr}^{c}. Similarly, for any current fisheye image of later sorted numbers, when supplementing feature points, the feature points of the current fisheye image can be tracked according to the supplemented fisheye feature points of all current fisheye images before the current fisheye image, until the number of supplemented fisheye feature points is equal to A_{ƒk}.

In addition, for the current frame ordinary image Fₚₒ^{c}, the number of ordinary feature points that need to be supplemented is Aₚₒ, and the number of ordinary feature points currently tracked is Tₚₒ. Among them, if Tₚₒ is smaller than Thₚ, Aₚₒ=Thₚ−Tₚₒ; if Tₚₒ=Thₚ, Aₚₒ=0.

For any current frame ordinary image, feature point tracking can be performed on the current frame ordinary image according to the supplemented fisheye feature points of each current frame fisheye image to obtain newly supplemented ordinary feature points of the current frame ordinary image. If the number of newly supplemented ordinary feature points of the current frame ordinary image is equal to the number of ordinary feature points that need to be supplemented Aₚₒ in the current frame ordinary image, the tracking of the current frame ordinary image is terminated. If the number of newly tracked ordinary feature points of the current frame ordinary image is less than Aₚₒ, then Aₚₒ−rₚ feature points are extracted from the current frame ordinary image, where rₚ represents the number of newly tracked ordinary feature points of the current frame ordinary image.

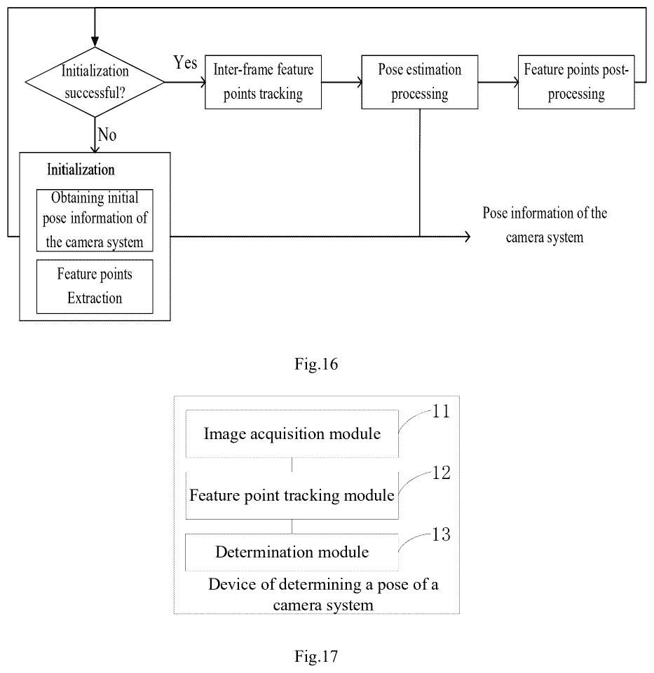

Exemplarily, a camera system includes a fisheye camera and a preset type of camera, the fisheye camera captures fisheye video (including the first frame fisheye image 1, the second frame fisheye image 2, the third frame fisheye image 3, the fourth frame fisheye image 4 and the fifth frame fisheye image 5), the preset type of camera captures ordinary video (including the first frame ordinary image 1, the second frame ordinary image 2, the third frame ordinary image 3, the fourth frame ordinary image 4 and the fifth frame ordinary image 5), and the fisheye video and the ordinary video have the same time period, as shown in FIG. 16, which is a flowchart of the pose estimation processing of the camera system. When performing pose estimation processing on the camera system, it can be initialized first by the first frame fisheye image 1 in the fisheye video and the first frame ordinary image 1 in the ordinary video.

In some embodiments, the above initialization process includes: obtaining initial pose information of the camera system in the first frame, and extracting feature points of fisheye image 1 and ordinary image 1 to obtain fisheye feature points 1 and ordinary feature points 2, respectively. At this time, it is determined that the initialization is completed; in addition, in the case that the feature point extraction of fisheye image 1 and ordinary image 1 fails, the initialization can be continued, and the feature point extraction of fisheye image 2 and ordinary image 2 continues. If the feature point extraction fails, the feature point extraction continues to the next frame of fisheye image and the next frame of ordinary image continues, until the feature point extraction is successful, and the initialization is determined to be completed. It should be noted here that if the feature point extraction of fisheye image 3 and ordinary image 3 is successful, it indicates that the initialization of the third frame is successful.

Furthermore, based on the successful initialization mentioned above, the third frame fisheye image 3 can be used to perform inter-frame feature tracking on the fourth frame fisheye image 4 to obtain fisheye feature points 4 of the fisheye image 4, and the third frame ordinary image 3 can be used to perform inter-frame feature tracking on the fourth frame ordinary image 4 to obtain ordinary feature points 4 of the ordinary image 4, and then the fisheye feature points 4, fisheye feature points 3, ordinary feature points 4 and ordinary feature points 3 are subjected to pose estimation processing to obtain the pose information of the camera system in the fourth frame.

Next, feature points post-processing is performed on the ordinary image 4 and the fisheye image 4 to obtain ordinary feature points 41 and fisheye feature points 41 respectively, and then inter-frame feature point tracking is performed after successful initialization, that is, inter-frame feature point tracking is performed on the fifth frame ordinary image 5 through the ordinary feature points 41, and inter-frame feature point tracking is performed on the fifth frame fisheye image 5 through the fisheye feature points 41, and then the pose estimation processing is performed on the camera system of the fifth frame to obtain the pose information of the camera system in the fifth frame. If both the ordinary image and the fisheye image include multiple frames, other frames can be processed according to the above steps to obtain the pose information of the camera system in each frame.

It should be noted here that if both the fisheye video and the ordinary video include only one frame of image, it is sufficient to obtain only the initial pose information of the camera system, and there is no need to extract feature points from the first frame image.

The technical solution in one embodiment of the present application can respectively construct non-depth residual functions of different non-depth feature points to provide basic information for constructing different non-depth information observation models; at the same time, the method does not require complex algorithms to be implemented, and the process is relatively simple, thereby improving the construction speed of the non-depth residual function; at the same time, the method can obtain the position coordinates of the non-depth feature points corresponding to the depth information, and on this basis, the method can finally determine the pose of the camera system when facing scenes such as weak textures and rapid camera motion, and still show high accuracy and good robustness.

In one embodiment, the present application also provides a method for determining the pose of a camera system, the method comprising the following process:
(1) obtaining the current frame fisheye image captured by each fisheye camera in the camera system and the current frame ordinary image captured by each preset type camera;
(2) obtaining historical frame fisheye feature points of historical frame fisheye images captured by each fisheye camera;
If the historical frame fisheye image includes a previous frame fisheye image of the current frame fisheye image, and the previous frame fisheye image is the initial frame fisheye image, then the above step (2) may include:
(21) obtaining the previous frame fisheye image captured by each fisheye camera.
(22) extracting a preset number of fisheye feature points from a target previous frame fisheye image among the previous frame fisheye images captured by each fisheye camera; the target previous frame fisheye image represents any one of the previous frame fisheye images.
(23) generating an image sequence from the previous frame fisheye images; the target previous frame fisheye image in the image sequence is the starting fisheye image.
(24) for any previous frame fisheye image in the image sequence, tracking the feature points from the previous frame fisheye image based on the feature points extracted from all previous frame fisheye images before the previous frame fisheye image.
(25) if the number of tracked feature points on the previous frame fisheye image is equal to the preset number of fisheye features, determining the tracked feature points as the previous frame fisheye feature points of the previous frame fisheye image;

Alternatively, if the number of feature points tracked on the previous frame fisheye image is less than the preset number of fisheye features, the number of compensating feature points of the previous frame fisheye image is determined based on the number of feature points tracked on the previous frame fisheye image and the preset number of fisheye features; based on the number of compensating feature points of the previous frame fisheye image, feature point compensation extraction is performed on the previous frame fisheye image to obtain the previous frame fisheye feature points of the previous frame fisheye image.
(3) obtaining historical frame ordinary feature points of historical frame ordinary images collected by cameras of each preset type;
If the historical frame fisheye image includes the previous frame fisheye image of the current frame fisheye image, the historical frame ordinary image includes the previous frame ordinary image of the current frame ordinary image, and the previous frame fisheye image is the initial frame fisheye image, and the previous frame ordinary image is the initial frame ordinary image, then the above step (3) may include:
(31) obtaining previous frame fisheye feature points of the previous frame fisheye image captured by each fisheye camera;
(32) for any previous frame ordinary image, performing tracking of the feature points of the previous frame ordinary image according to the fisheye feature points of each previous frame to obtain candidate ordinary feature points of the previous frame ordinary image;
(33) if the number of candidate ordinary feature points of the previous frame ordinary image is equal to the preset number of ordinary features, determining the candidate ordinary feature points of the previous frame ordinary image as the previous frame ordinary feature points of the previous frame ordinary image;

Alternatively, if the number of candidate ordinary feature points of the previous frame ordinary image is less than the preset number of ordinary features, the number of compensating feature points of the previous frame ordinary image is determined based on the total number of candidate ordinary feature points of the previous frame ordinary image and the preset number of ordinary features; based on the number of compensating feature points of the previous frame ordinary image, feature point compensation extraction is performed on the previous frame ordinary image; based on the feature point compensation extraction result of the previous frame ordinary image and the candidate ordinary feature points, the previous frame ordinary feature points of the previous frame ordinary image are determined.
(4) tracking inter-frame feature points of the current frame ordinary image based on the previous frame ordinary feature points of the previous frame ordinary image to obtain candidate ordinary feature points of the current frame ordinary image;
(5) if the number of candidate ordinary feature points of the current frame ordinary image is equal to the preset number of ordinary features, determining the candidate ordinary feature points of the current frame ordinary image as the current frame ordinary feature points; alternatively, if the number of candidate ordinary feature points of the current frame ordinary image is less than the preset number of ordinary features, the feature points of the current frame ordinary image are tracked according to the previous frame ordinary feature points of the previous frame ordinary image captured by the preset type camera, so as to determine the current frame ordinary feature points of the current frame ordinary image.
(6) obtaining the previous frame fisheye feature points of the previous frame fisheye image captured by each fisheye camera, and the previous frame ordinary feature points of the previous frame ordinary image captured by each preset type of camera.
(7) obtaining depth feature points having depth information from the current frame fisheye feature points and the current frame ordinary feature points; the depth feature points include three-dimensional position coordinates of the feature points.
(8) determining unit sphere coordinates of each depth feature point according to current position coordinates of each depth feature point in the current frame image to which it belongs.
(9) determining the depth residual function of each depth feature point based on the current position coordinates of each depth feature point in the world coordinate system and the unit sphere coordinates of each depth feature point, as well as an external parameter between the current camera system coordinate system and the camera coordinate system corresponding to the current frame image to which each depth feature point belongs.
(10) determining the depth information observation model based on the depth residual function of each depth feature point.
(11) obtaining a plurality of first non-depth feature points, a plurality of second non-depth feature points and a plurality of third non-depth feature points from each current frame fisheye feature point and each current frame ordinary feature point; wherein each first non-depth feature point represents a current frame feature point without depth information that is in at least two current frame images and in at least two previous frame images; each second non-depth feature point represents a current frame feature point without depth information that is in only one current frame image and in at least two previous frame images; each third non-depth feature point represents a current frame feature point without depth information that is in at least two current frame images and in only one previous frame image; the current frame image is either the current frame fisheye image or the current frame ordinary image; the previous frame image is either the previous frame fisheye image or the previous frame ordinary image.
(12) obtaining previous position coordinates of each first non-depth feature point on the previous frame image.
(13) triangulating the previous position coordinates of each first non-depth feature point to obtain the three-dimensional previous position coordinates of each first non-depth feature point in the world coordinate system; and triangulating the current position coordinates of each first non-depth feature point to obtain the three-dimensional current position coordinates of each first non-depth feature point in the current camera system coordinate system.
(14) constructing a non-depth residual function of each first non-depth feature point according to the three-dimensional previous position coordinates of each first non-depth feature point in the world coordinate system and the three-dimensional current position coordinates of each first non-depth feature point in the current camera system coordinate system.
(15) obtaining previous position coordinates of each second non-depth feature point on the previous frame image to which it belongs.
(16) triangulating the previous position coordinates of each second non-depth feature point to obtain the three-dimensional previous position coordinates of each second non-depth feature point in the world coordinate system.
(17) determining unit sphere coordinates of each second non-depth feature point according to the current position coordinates of each second non-depth feature point in the current frame image to which it belongs.
(18) constructing a non-depth residual function of each second non-depth feature point based on the three-dimensional previous position coordinates of each second non-depth feature point in the world coordinate system, the unit sphere coordinates of each second non-depth feature point, and the external parameter between the current camera system coordinate system and the camera coordinate system corresponding to the current frame image to which each second non-depth feature point belongs.
(19) triangulating the current position coordinates of each third non-depth feature point on the current frame image to obtain the three-dimensional current position coordinates of each third non-depth feature point in the current camera coordinate system.
(20) determining unit sphere coordinates of each third non-depth feature point according to the previous position coordinates of each third non-depth feature point in the previous frame image.
(21) constructing a non-depth residual function of each third non-depth feature point based on the three-dimensional current position coordinates of each third non-depth feature point in the current camera coordinate system, the unit sphere coordinates of each third non-depth feature point, transformation relationship between the world coordinate system and the previous camera system coordinate system, and the external parameter between the current camera system coordinate system and the camera coordinate system corresponding to the previous frame image to which each third non-depth feature point belongs.
(22) determining a non-depth information observation model according to the non-depth residual function of each first non-depth feature point, the non-depth residual function of each second non-depth feature point, and the non-depth residual function of each third non-depth feature point.
(23) based on the non-depth information observation model, constructing a current pose optimization function of the camera system.
(24) based on the current pose optimization function, determining current pose information of the camera system.
the above (1) to (24) can be specifically referred to the description of the above embodiment. The implementation principle and technical effect are similar and will not be repeated here.

It should be understood that, although the steps in the flowcharts involved in the above embodiments are displayed in sequence according to the indication of the arrows, these steps are not necessarily executed in sequence according to the order indicated by the arrows. Unless there is a clear explanation in this disclosure, the execution of these steps is not strictly limited in order, and these steps can be executed in other orders. Moreover, at least a part of the steps in the flowcharts involved in the above embodiments may include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, one embodiment of the present application also provides a camera system pose determination device for implementing the above-mentioned camera system pose determination method. The implementation solution provided by the device to solve the problem is similar to the implementation solution recorded in the above-mentioned method, so the specific limitations in the embodiments of the pose determination device for one or more camera systems provided below can refer to the limitations of the camera system pose determination method above, and will not be repeated here.

In one embodiment, FIG. 17 is a schematic diagram of a structure of a device for determining a pose of a camera system in an embodiment of the present application. The device for determining the pose of a camera system provided in the embodiment of the present application can be applied to a computer device. As shown in FIG. 17, the device for determining the pose of a camera system in one embodiment of the present application may include: an image acquisition module or circuitry 11, a feature point tracking module or circuitry 12, and a determination module or circuitry 13, wherein:
An image acquisition module 11 is used to acquire a current frame fisheye image acquired by a fisheye camera in a camera system and a current frame ordinary image acquired by a preset type camera;
A feature point tracking module 12 is used to track the feature points of the current frame fisheye image to obtain the current frame fisheye feature points of the current frame fisheye image, and to track the feature points of the current frame ordinary image to obtain the current frame ordinary feature points of the current frame ordinary image;
The determination module 13 is used to determine the current pose information of the camera system according to the current frame fisheye feature points and the current frame ordinary feature points.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the feature point tracking module 12 includes: a first acquisition unit or structure and a first feature point tracking unit or structure, wherein:
The first acquisition unit is configured to acquire historical frame fisheye feature points of historical frame fisheye images acquired by the fisheye camera;
The first feature point tracking unit is configured to track the inter-frame feature points of the current frame fisheye image according to the historical frame fisheye feature points to obtain the current frame fisheye feature points of the current frame fisheye image.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the camera system includes at least one fisheye camera. If the historical frame fisheye image includes a previous frame fisheye image of the current frame fisheye image, and the previous frame fisheye image is the initial frame fisheye image, the first acquisition unit includes: a first acquisition subunit, a first extraction subunit and a second extraction subunit, wherein:
The first acquisition subunit is configured to acquire the previous frame fisheye image captured by each fisheye camera;
The first extraction subunit is configured to extract a preset number of fisheye feature points from a target previous frame fisheye image among the previous frame fisheye images; the target previous frame fisheye image represents any one of the previous frame fisheye images;
The second extraction subunit is configured to extract feature points on other previous fisheye images among the previous fisheye images in turn according to the feature points extracted on the target previous fisheye image so as to obtain the previous fisheye feature points of the previous fisheye image captured by each fisheye camera.

The device for determining the pose of a camera system provided in one embodiment of the present application can be configured to execute the technical solution in the embodiment of the method for determining the pose of a camera system described above in the present application. The implementation principle and technical effects are similar and will not be repeated here.

In one embodiment, the second extraction subunit is specifically used for:
generating an image sequence from each previous frame of fisheye image; the target previous frame of fisheye image in the image sequence is the starting fisheye image;
For any previous fisheye image in the image sequence, the feature points are tracked from the previous fisheye image according to the feature points extracted from all previous fisheye images before the previous fisheye image;
If the number of tracked feature points on the previous frame fisheye image is equal to the preset number of fisheye features, the tracked feature points are used as the previous frame fisheye feature points of the previous frame fisheye image.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the second extraction subunit is further configured to:
if the number of feature points tracked on the previous frame fisheye image is less than the preset number of fisheye features, determine the number of compensating feature points of the previous frame fisheye image according to the number of feature points tracked on the previous frame fisheye image and the preset number of fisheye features; and
according to the number of compensated feature points of the previous frame fisheye image, perform feature point compensation extraction on the previous frame fisheye image to obtain the previous frame fisheye feature points of the previous frame fisheye image.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the feature point tracking module 12 further includes: a second acquisition unit, a second feature point tracking unit and a first determination unit, wherein:
the second acquisition unit is configured to acquire historical frame ordinary feature points of historical frame ordinary images captured by a preset type of camera;
the second feature point tracking unit is configured to track the inter-frame feature points of the current frame ordinary image according to the historical frame ordinary feature points of the historical frame ordinary image, so as to obtain candidate ordinary feature points of the current frame ordinary image; and
the first determination unit is configured to determine the candidate ordinary feature points of the current frame ordinary image as the current frame ordinary feature points of the current frame ordinary image when the number of candidate ordinary feature points of the current frame ordinary image is equal to the preset number of ordinary features.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the camera system includes at least one fisheye camera, if the historical frame fisheye image includes a previous frame fisheye image of the current frame fisheye image, the historical frame ordinary image includes a previous frame ordinary image of the current frame ordinary image, and the previous frame fisheye image is an initial frame fisheye image, and the previous frame ordinary image is an initial frame ordinary image, then the second acquisition unit includes: a second acquisition subunit, a first tracking subunit and a first determination subunit, wherein:
the second acquisition subunit is configured to acquire the previous frame fisheye feature points of the previous frame fisheye image captured by each fisheye camera;
the first tracking subunit is configured to track the feature points of the previous frame ordinary image according to the previous frame fisheye feature points so as to obtain candidate ordinary feature points of the previous frame ordinary image;
the first determination subunit is configured to determine the candidate ordinary feature points of the previous frame ordinary image as the previous frame ordinary feature points of the previous frame ordinary image when the number of candidate ordinary feature points of the previous frame ordinary image is equal to the preset number of ordinary features.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the second acquisition unit further includes: a second determination subunit, a feature point extraction subunit and a third determination subunit, wherein:
the second determination subunit is configured to determine the number of compensating feature points of the previous frame ordinary image according to the total number of candidate ordinary feature points of the previous frame ordinary image and the preset number of ordinary features when the number of candidate ordinary feature points of the previous frame ordinary image is less than the preset number of ordinary features;
the feature point extraction subunit is configured to perform feature point compensation extraction on the previous frame ordinary image according to the number of compensated feature points of the previous frame ordinary image; and
the third determination subunit is configured to determine the previous frame ordinary feature points according to the feature point compensation extraction result of the previous frame the ordinary image and the candidate ordinary feature points.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the feature point tracking module 12 further includes: a third feature point tracking unit, wherein:
the third feature point tracking unit is configured to track the feature points of the current frame ordinary image according to the historical frame ordinary feature points of the historical frame ordinary images collected by a preset type of camera when the number of candidate ordinary feature points of the current frame ordinary image is less than the preset number of ordinary features, so as to determine the current frame ordinary feature points of the current frame ordinary image.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the determination module 13 includes: a feature point acquisition unit, an observation model construction unit, an optimization function construction unit and a pose information determination unit, wherein:
the feature point acquisition unit is configured to acquire the previous frame fisheye feature points of the previous frame fisheye image acquired by the fisheye camera, and the previous frame ordinary feature points of the previous frame ordinary image acquired by the preset type camera;
the observation model construction unit is configured to build a current pose observation model of the camera system according to the current frame fisheye feature points, the previous frame fisheye feature points, the current frame ordinary feature points and the previous frame ordinary feature points;
the optimization function construction unit is configured to construct a current pose optimization function of the camera system according to the current pose observation model; and
the pose information determination unit is configured to determine the current pose information of the camera system according to the current pose optimization function.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the current pose observation model includes a depth information observation model and a non-depth information observation model; the observation model construction unit includes: a first construction subunit and a second construction subunit, wherein:
the first construction subunit is configured to determine a depth information observation model according to current frame fisheye feature points and current frame ordinary feature points; and
the second construction subunit is configured to construct a non-depth information observation model according to the current frame fisheye feature points, the previous frame fisheye feature points, the current frame ordinary feature points and the previous frame ordinary feature points.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the first construction subunit is specifically used for:
obtaining depth feature points with depth information from the current frame fisheye feature points and the current frame ordinary feature points; the depth feature points include three-dimensional position coordinates of the feature points;
determining unit sphere coordinates of each depth feature point according to the current position coordinates of each depth feature point in the current frame image; and
determining a depth residual function of each depth feature point according to the current position coordinates of each depth feature point in the world coordinate system and the unit sphere coordinates of each depth feature point, as well as an external parameter between the current camera system coordinate system and the camera coordinate system corresponding to the current frame image to which each depth feature point belongs;

The depth information observation model is determined according to the depth residual function of each depth feature point.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the second construction subunit includes: a non-depth feature point acquisition subunit, a residual function construction subunit and an observation model determination subunit, wherein:
the non-depth feature point acquisition subunit is configured to acquire a plurality of first non-depth feature points, a plurality of second non-depth feature points and a plurality of third non-depth feature points from the current frame fisheye feature points and the current frame ordinary feature points;
the residual function construction subunit is configured to construct a non-depth residual function of each first non-depth feature point, a non-depth residual function of each second non-depth feature point, and a non-depth residual function of each third non-depth feature point; and
the observation model determination subunit is configured to determine a non-depth information observation model according to a non-depth residual function of each first non-depth feature point, a non-depth residual function of each second non-depth feature point, and a non-depth residual function of each third non-depth feature point;
Among them, each first non-depth feature point represents a current frame feature point without depth information that is in at least two current frame images and in at least two previous frame images; each second non-depth feature point represents a current frame feature point without depth information that is only in one current frame image and in at least two previous frame images; each third non-depth feature point represents a current frame feature point without depth information that is in at least two current frame images and only in one previous frame image; the current frame image is either the current frame fisheye image or the current frame ordinary image; the previous frame image is either the previous frame fisheye image or the previous frame ordinary image.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the residual function construction subunit is specifically used for:
obtaining the previous position coordinates of each first non-depth feature point on the corresponding previous frame image;
triangulating the previous position coordinates of each first non-depth feature point to obtain the three-dimensional previous position coordinates of each first non-depth feature point in the world coordinate system; and triangulating the current position coordinates of each first non-depth feature point to obtain the three-dimensional current position coordinates of each first non-depth feature point in the current camera system coordinate system;
constructing a non-depth residual function of each first non-depth feature point according to the three-dimensional previous position coordinates of each first non-depth feature point in the world coordinate system and the three-dimensional current position coordinates of each first non-depth feature point in the current camera system coordinate system.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the residual function construction subunit is further used for:
obtaining the previous position coordinates of each second non-depth feature point on the corresponding previous frame image;
triangulating the previous position coordinates of each second non-depth feature point to obtain the three-dimensional previous position coordinates of each second non-depth feature point in the world coordinate system;
determining unit sphere coordinates of each second non-depth feature point according to the current position coordinates of each second non-depth feature point in the current frame image to which it belongs; and
constructing a non-depth residual function of each second non-depth feature point according to the three-dimensional previous position coordinates of each second non-depth feature point in the world coordinate system, the unit sphere coordinates of each second non-depth feature point, and the external parameter between the current camera system coordinate system and the camera coordinate system corresponding to the current frame image to which each second non-depth feature point belongs.

The device for determining the pose of a camera system provided in the embodiment of the present application can be used to execute the technical solution in the embodiment of the method for determining the pose of a camera system described above in the present application. The implementation principle and technical effects are similar and will not be repeated here.

In one embodiment, the residual function construction subunit is further used for:
triangulating the current position coordinates of each third non-depth feature point on the current frame image to obtain the three-dimensional current position coordinates of each third non-depth feature point in the current camera coordinate system;
determining unit sphere coordinates of each third non-depth feature point according to the previous position coordinates of each third non-depth feature point in the corresponding previous frame image;
constructing a non-depth residual function of each third non-depth feature point according to the three-dimensional current position coordinates of each third non-depth feature point in the current camera coordinate system, the unit sphere coordinates of each third non-depth feature point, transformation relationship between the world coordinate system and the previous camera system coordinate system, and an external parameter between the current camera system coordinate system and the camera coordinate system corresponding to the previous frame image to which each third non-depth feature point belongs,
The device for determining the pose of a camera system provided in the embodiment of the present application can be used to execute the technical solution in the embodiment of the method for determining the pose of a camera system described above in the present application. The implementation principle and technical effects are similar and will not be repeated here.

For the specific definition of the pose determination device of the camera system, please refer to the definition of the pose determination method of the camera system above, which will not be repeated here. Each module in the pose determination device of the above-mentioned camera system can be implemented in whole or in part by software, hardware and a combination thereof. The above-mentioned modules can be embedded in or independent of the processor in the computer device in the form of hardware, or can be stored in the memory of the computer device in the form of software, so that the processor can call and execute the operations corresponding to the above modules.

In one embodiment, a movable platform is further provided. Referring to FIG. 1, the movable platform includes:
a body;
a power system arranged in the body, and the power system is used to provide power for the movable platform;
a camera system;
at least one processor; and
at least one memory for storing a computer program for execution by the at least one processor;

When the at least one processor executes the computer program, the steps of the method in any of the above embodiments are implemented.

The movable platform provided in one embodiment of the present application can be used to execute the technical solution in the embodiment of the method for determining the pose of the camera system mentioned above in the present application. Its implementation principle and technical effect are similar and will not be repeated here.

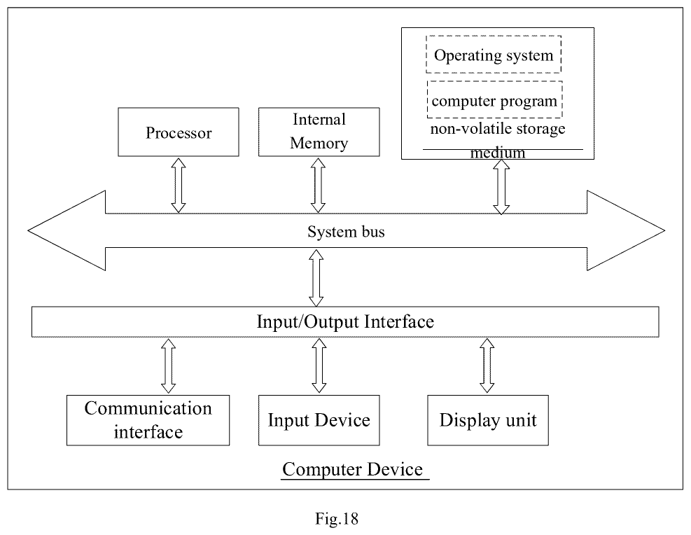

In one embodiment, a computer device is also provided, and the internal structural diagram of the computer device can be shown in FIG. 18. The computer device includes a processor, a memory and a network interface connected through a system bus. Among them, the processor of the computer device is used to provide processing capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device is used to store each current frame fisheye image, each current frame ordinary image, each previous frame fisheye image and each previous frame ordinary image. The network interface of the computer device is used to communicate with an external end point through a network connection. When the computer program is executed by the processor, a method for determining the pose of a camera system is implemented.

Those skilled in the art will understand that the structure shown in FIG. 18 is merely a block diagram of a partial structure related to the scheme of the present application, and does not constitute a limitation on the computer device to which the scheme of the present application is applied. The specific computer device may include more or fewer components than shown in the figure, or combine certain components, or have a different arrangement of components.

In one embodiment, a computer device is provided, including at least one memory and at least one processor. The at least one memory stores a computer program, and the at least one processor implements the steps of the method in any of the above embodiments when executing the computer program.

In one embodiment, a computer-readable storage medium is further provided, on which a computer program is stored. When the computer program is executed by a processor, the steps of the method in any of the above embodiments are implemented.

In one embodiment, a computer program product is also provided, including a computer program, which implements the steps of the method in any of the above embodiments when executed by a processor.

In one embodiment, the pose information of the camera system can be used for anti-shake. The pose information of the camera system can be used to identify image jitter and correct the image jitter to achieve anti-shake processing. For example, the position of the image frame can be adjusted based on the pose information of the camera system to reduce or eliminate the impact of jitter to obtain a stable image or video output.

In one embodiment, the pose information of the camera system can be used for navigation. In the navigation system, the pose information of the camera system helps the device (such as a drone) understand its orientation in the environment to achieve navigation. For example, based on the pose information of the camera system, the current position of the device can be calculated in real time compared to the pre-built map, thereby generating an accurate path and achieving navigation.

In one embodiment, based on the pose information of the camera system carried by the drone, the drone can be assisted in completing different aspects of control such as perception (such as tracking, obstacle avoidance, etc.), flight control, and flight planning.

Those of ordinary skill in the art can understand that all or part of the processes in the above-mentioned embodiment methods can be completed by instructing the relevant hardware through a computer program, and the computer program can be stored in a non-volatile computer-readable storage medium. When the computer program is executed, it can include the processes of the embodiments of the above-mentioned methods. Among them, any reference to memory, storage, database or other media used in the embodiments provided in this application can include at least one of non-volatile and volatile memory. Non-volatile memory can include read-only memory (ROM), tape, floppy disk, flash memory or optical memory, etc. Volatile memory can include random access memory (RAM) or external cache memory. As an illustration and not limitation, RAM can be in various forms, such as static random access memory (SRAM) or dynamic random access memory (DRAM).

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-mentioned embodiments only express several implementation methods of the present application, and the descriptions thereof are relatively specific and detailed, but they cannot be understood as limiting the scope of the invention patent. It should be pointed out that, for a person of ordinary skill in the art, several variations and improvements can be made without departing from the concept of the present application, and these all belong to the protection scope of the present application. Therefore, the protection scope of the patent of the present application shall be subject to the attached claims.

What is claimed is:

1. A method for determining a pose of a camera system, comprising:
obtaining a current frame fisheye image captured by a fisheye camera in the camera system and a current frame ordinary image captured by a preset type of camera in the camera system;
tracking feature points of the current frame fisheye image to obtain current frame fisheye feature points of the current frame fisheye image, and tracking feature points of the current frame ordinary image to obtain current frame ordinary feature points of the current frame ordinary image; and
determining current pose information of the camera system according to the current frame fisheye feature points and the current frame ordinary feature points.

2. The method according to claim 1, wherein the tracking feature points of the current frame fisheye image to obtain the current frame fisheye feature points of the current frame fisheye image comprises:
acquiring historical frame fisheye feature points of historical frame fisheye images captured by the fisheye camera; and
performing inter-frame feature point tracking on the current frame fisheye image according to the historical frame fisheye feature points to obtain the current frame fisheye feature points of the current frame fisheye image.

3. The method according to claim 2, wherein, the camera system comprises at least one fisheye camera, and the acquiring the historical frame fisheye feature points of the historical frame fisheye image captured by the fisheye camera comprises:
acquiring a previous frame fisheye image captured by each of the at least one fisheye camera, the previous frame fisheye image being an initial frame fisheye image;
extracting a preset number of fisheye feature points from a target previous frame fisheye image, the target previous frame fisheye image represents one previous frame fisheye image captured by one of the at least one fisheye camera in the camera system; and
extracting feature points from the previous frame fisheye image captured by each of other fisheye cameras in the camera system in turn according to the fisheye feature points extracted from the target previous frame fisheye image to obtain the previous frame fisheye feature points of the previous frame fisheye image captured by each of the at least one fisheye camera.

4. The method according to claim 3, wherein the extracting feature points from the previous frame fisheye image captured by each of other fisheye cameras in the camera system in turn according to the fisheye feature points extracted from the target previous fisheye image comprises:
generating an image sequence from the previous frame fisheye image captured by each of the at least one fisheye camera in the camera system, the target previous target fisheye image being a starting fisheye image in the image sequence;
tracking feature points from one previous frame fisheye image in the image sequence according to feature points extracted from all previous frame fisheye images before the one previous frame fisheye image in the image sequence; and
in a case that the number of feature points tracked on the one previous frame of fisheye image is equal to a preset number of fisheye features, determining the tracked feature points as the previous frame fisheye feature points of the previous frame fisheye image.

5. The method according to claim 4, wherein the extracting feature points from the previous frame fisheye image captured by each of other fisheye cameras in the camera system in turn according to the fisheye feature points extracted from the target previous fisheye image further comprises:
in a case that the number of feature points tracked on the one previous frame fisheye image is less than the preset number of fisheye features, determining a number of compensating feature points of the previous frame fisheye image according to the number of feature points tracked on the previous frame fisheye image and the preset number of fisheye features; and
performing feature point compensation extraction on the previous frame fisheye image according to the number of compensated feature points of the previous frame fisheye image to obtain the previous frame fisheye feature points of the previous frame fisheye image.

6. The method according to claim 2, wherein the tracking feature points of the current frame ordinary image to obtain the current frame ordinary feature points of the current frame ordinary image comprises:
acquiring historical ordinary feature points of historical frame ordinary images captured by the preset type of camera;
according to the historical frame ordinary feature points of the historical frame ordinary image, performing inter-frame feature point tracking on the current frame ordinary image to obtain candidate ordinary feature points of the current frame ordinary image; and
in a case that the number of candidate ordinary feature points of the current frame ordinary image is equal to a preset number of ordinary features, determining the candidate ordinary feature points of the current frame ordinary image as the current frame ordinary feature points of the current frame ordinary image.

7. The method according to claim 6, wherein the camera system includes at least one fisheye camera; the historical frame fisheye image includes a previous frame fisheye image of the current frame fisheye image, the historical frame ordinary image includes a previous frame ordinary image of the current frame ordinary image, and the previous frame fisheye image is an initial frame fisheye image, and the previous frame ordinary image is an initial frame ordinary image, the acquiring the historical frame ordinary feature points of the historical frame ordinary image captured by the preset type camera comprises:
acquiring the previous frame fisheye feature points of the previous frame fisheye image captured by each of the at least one fisheye camera;
tracking feature points of the previous frame ordinary image according to each of the previous frame fisheye feature points to obtain candidate ordinary feature points of the previous frame ordinary image;
in a case that the number of candidate ordinary feature points of the previous frame ordinary image is equal to the preset number of ordinary features, determining the candidate ordinary feature points of the previous frame ordinary image as the previous frame ordinary feature points of the previous frame ordinary image.

8. The method according to claim 7, wherein the previous frame ordinary image is an initial frame ordinary image, the acquiring the historical frame ordinary feature points of the historical frame ordinary image captured by the preset type of camera further comprises:
in a case that the number of candidate ordinary feature points of the previous frame ordinary image is less than the preset number of ordinary features, determining a number of compensating feature points of the previous frame ordinary image according to the number of candidate ordinary feature points of the previous frame ordinary image and the preset number of ordinary features;
performing feature point compensation extraction of the previous frame ordinary image according to the number of compensating feature points of the previous frame ordinary image; and
determining the ordinary feature points of the previous frame according to a result of the feature point compensation extraction of the previous frame ordinary image and the candidate ordinary feature points.

9. The method according to claim 6, wherein the tracking feature points of the current frame ordinary image to obtain the current frame ordinary feature points of the current frame ordinary image further comprises:
in a case that the number of candidate ordinary feature points of the current frame ordinary image is less than the preset number of ordinary features, performing feature point tracking on the current frame ordinary image according to the historical frame ordinary feature points of the historical frame ordinary images captured by the preset type of camera to determine the current frame ordinary feature points of the current frame ordinary image.

10. The method according to claim 1, wherein the determining the current pose information of the camera system according to the current frame fisheye feature points and the current frame ordinary feature points comprises:
acquire previous frame fisheye feature points of a previous frame fisheye image captured by each of at least one fisheye camera in the camera system and previous frame ordinary feature points of the previous frame ordinary image captured by the preset type camera;
constructing a current pose observation model of the camera system according to the current frame fisheye feature points, the previous frame fisheye feature points, the current frame ordinary feature points and the previous frame ordinary feature points;
constructing a current pose optimization function of the camera system according to the current pose observation model; and
determining the current pose information of the camera system based on the current pose optimization function.

11. The method according to claim 10, wherein the current pose observation model includes a depth information observation model and a non-depth information observation model; and constructing the current pose observation model of the camera system according to the current frame fisheye feature points, the previous frame fisheye feature points, the current frame ordinary feature points and the previous frame ordinary feature points comprises:
determining the depth information observation model according to the current frame fisheye feature points and the current frame ordinary feature points; and
determining the non-depth information observation model according to the current frame fisheye feature points, the previous frame fisheye feature points, the current frame ordinary feature points and the previous frame ordinary feature points.

12. The method according to claim 11, wherein the determining the depth information observation model according to the current frame fisheye feature points and the current frame ordinary feature points comprises:
acquire depth feature points having depth information from the current frame fisheye feature points and the current frame ordinary feature points; the depth information including three-dimensional position coordinates of the depth feature points;
determining unit sphere coordinates of each of the depth feature points according to current position coordinates of each of the depth feature points in the current frame fisheye image or the current frame ordinary image to which it belongs;
determine a depth residual function of each of the depth feature points according to the current position coordinates of each of the depth feature points in a world coordinate system and the unit sphere coordinates of each of the depth feature points, as well as an external parameter between a current camera system coordinate system and a camera coordinate system corresponding to a current frame fisheye image or current frame ordinary image to which the each of the depth feature point belongs; and
determining the depth information observation model according to the depth residual function of each of the depth feature points.

13. The method according to claim 11, wherein the determining the non-depth information observation model according to the current frame fisheye feature points, the previous frame fisheye feature points, the current frame ordinary feature points and the previous frame ordinary feature points comprises:
acquiring a plurality of first non-depth feature points, a plurality of second non-depth feature points, and a plurality of third non-depth feature points from the current frame fisheye feature points and the current frame ordinary feature points;
constructing a non-depth residual function of each of the first non-depth feature points, a non-depth residual function of each of the second non-depth feature points, and a non-depth residual function of each of the third non-depth feature points; and
determining the non-depth information observation model according to the non-depth residual function of each of the first non-depth feature points, the non-depth residual function of each of the second non-depth feature points, and the non-depth residual function of each of the third non-depth feature points.

14. The method according to claim 13, wherein
each of the first non-depth feature points represents a current frame feature point without depth information that is in at least two current frame images and in at least two previous frame images;
each of the second non-depth feature points represents a current frame feature point without depth information that is only in one current frame image and in at least two previous frame images;
each of the third non-depth feature points represents a current frame feature point without depth information that is in at least two current frame images and in only one previous frame image; and
each of the current frame images is either a current frame fisheye image or a current frame ordinary image, and each of the previous frame images is either a previous frame fisheye image or a previous frame ordinary image.

15. The method according to claim 14, wherein the constructing the non-depth residual function of each of the first non-depth feature points comprises:
obtaining previous position coordinates of each of the first non-depth feature points on the corresponding previous frame image;
performing triangulation processing on the previous position coordinates of each of the first non-depth feature points to obtain three-dimensional previous position coordinates of each of the first non-depth feature points in the world coordinate system; and performing triangulation processing on current position coordinates of each of the first non-depth feature points to obtain three-dimensional current position coordinates of each of the first non-depth feature points in the current camera system coordinate system; and
constructing the non-depth residual function of each of the first non-depth feature points according to the three-dimensional previous position coordinates of each of the first non-depth feature points in the world coordinate system and the three-dimensional current position coordinates of each of the first non-depth feature points in the current camera system coordinate system.

16. The method according to claim 14, wherein the constructing the non-depth residual function of each of the second non-depth feature points comprises:
obtaining previous position coordinates of each of the second non-depth feature points on the corresponding previous frame image;
performing triangulation processing on previous position coordinates of each of the second non-depth feature points to obtain three-dimensional previous position coordinates of each of the second non-depth feature points in the world coordinate system;
determining unit sphere coordinates of each of the second non-depth feature points according to current position coordinates of each of the second non-depth feature points in the current frame image to which it belongs; and
constructing the non-depth residual function of each second non-depth feature point according to the three-dimensional previous position coordinates of each of the second non-depth feature points in the world coordinate system, the unit sphere coordinates of each of the second non-depth feature points, and an external parameter between the current camera system coordinate system and the camera coordinate system corresponding to the current frame image to which each of the second non-depth feature points belongs.

17. The method according to claim 14, wherein the constructing the non-depth residual function of each of the third non-depth feature points comprises:
performing triangulation processing on current position coordinates of each of the third non-depth feature points on the corresponding current frame image to obtain three-dimensional current position coordinates of each of the third non-depth feature points in the current camera coordinate system;
determining unit sphere coordinates of each of the third non-depth feature points according to the previous position coordinates of each of the third non-depth feature points in the previous frame image to which it belongs; and
constructing the non-depth residual function of each of the third non-depth feature points according to the three-dimensional current position coordinates of each of the third non-depth feature points in the current camera coordinate system, the unit sphere coordinates of each of the third non-depth feature points, and transformation relationship between the world coordinate system and the previous camera system coordinate system, and an external parameter between the current camera system coordinate system and the camera coordinate system corresponding to the previous frame image to which each of the third non-depth feature points belongs.

18. A movable platform, comprising:
a camera system;
at least one memory; and
at least one processor,
wherein the at least one memory stores a computer program which, when executed by the at least one processor, causes the at least one processor to perform the following:
obtaining a current frame fisheye image captured by a fisheye camera in the camera system and a current frame ordinary image captured by a preset type of camera in the camera system;
tracking feature points of the current frame fisheye image to obtain current frame fisheye feature points of the current frame fisheye image, and tracking feature points of the current frame ordinary image to obtain current frame ordinary feature points of the current frame ordinary image; and
determining current pose information of the camera system according to the current frame fisheye feature points and the current frame ordinary feature points.

19. A device for determining a pose of a camera system, comprising:
at least one memory; and
at least one processor,
wherein the at least one memory stores a computer program which, when executed by the at least one processor, causes the at least one processor to perform the following:
obtaining a current frame fisheye image captured by a fisheye camera in the camera system and a current frame ordinary image captured by a preset type of camera in the camera system;
tracking feature points of the current frame fisheye image to obtain current frame fisheye feature points of the current frame fisheye image, and tracking feature points of the current frame ordinary image to obtain current frame ordinary feature points of the current frame ordinary image; and
determining current pose information of the camera system according to the current frame fisheye feature points and the current frame ordinary feature points.

20. The device according to claim 19, wherein the tracking feature points of the current frame fisheye image to obtain the current frame fisheye feature points of the current frame fisheye image comprises:
acquiring historical frame fisheye feature points of historical frame fisheye images captured by the fisheye camera; and
performing inter-frame feature point tracking on the current frame fisheye image according to the historical frame fisheye feature points to obtain the current frame fisheye feature points of the current frame fisheye image.
